(19) United States
(12) Patent Application Publication
(10) Pub. No.: US 2024/0233770 A1
(43) Pub. Date: Jul. 11, 2024

(54) IMAGE PROCESSING APPARATUS, IMAGE PROCESSING METHOD, AND PROGRAM

(71) Applicant: Sony Group Corporation, Tokyo (JP)

(72) Inventors: Akiyo Fukuda, Kanagawa (JP); Tatsuyoshi Tonami, Chiba (JP); Ayako Chiba, Tokyo (JP); Jun Suzuki, Chiba (JP); Hiroki Shiina, Kanagawa (JP); Yuya Yamashita, Kanagawa (JP); Kanako Yana, Tokyo (JP)

(21) Appl. No.: 18/558,295

(22) PCT Filed: Dec. 1, 2021
(86) PCT No.: PCT/JP2021/044138

§ 371 Date: Oct. 31, 2023

Related U.S. Application Data
(60) Provisional application No. 63/187,569, filed on May 12, 2021.

(51) Int. Cl. G11B 27/031; G11B 27/34

(52) U.S. Cl. CPC G11B 27/031; G11B 27/34

(57) ABSTRACT

The present disclosure provides an image processing apparatus, an image processing method, and a program that make it possible to provide a video production service that is highly satisfying to a user.

There is provided an image processing apparatus including: a processing unit that acquires an image to which metadata is added, selects, on the basis of a time length of video to be produced and the metadata, the image to be used for production of the video from the acquired images, the time length being set on a setting screen, and produces the video using the selected image. The present disclosure is applicable to, for example, a cloud server that provides a service via the Internet.

### TECHNICAL FIELD

The present disclosure relates to an image processing apparatus, an image processing method, and a program, and particularly to an image processing apparatus, an image processing method, and a program that make it possible to provide a video production service that is highly satisfying to a user.

### BACKGROUND ART

A program that has a function of automatically editing an image such as a still image and video taken by a user is provided. For example, Patent Literature 1 discloses a program that designates a template as a program that automatically edits video.

### CITATION LIST

### Patent Literature

Patent Literature 1: Japanese Patent Application Laid-open No. 2009-55152

### DISCLOSURE OF INVENTION

### Technical Problem

When providing a video production service that edits an image to produce video, it is required to provide a service that satisfies a user. In particular, a user who is not proficient in video editing was not able to master a video editing function and was not able to produce satisfactory video.

The present disclosure has been made in view of the above-mentioned circumstances and it is an object thereof to provide a video production service that is highly satisfying to a user.

### Solution to Problem

An image processing apparatus according to an aspect of the present disclosure is an image processing apparatus including: a processing unit that acquires an image to which metadata is added, selects, on the basis of a time length of video to be produced and the metadata, the image to be used for production of the video from the acquired images, the time length being set on a setting screen, and produces the video using the selected image.

An image processing method according to an aspect of the present disclosure is an image processing method including: by an image processing apparatus, acquiring an image to which metadata is added; selecting, on the basis of a time length of video to be produced and the metadata, the image to be used for production of the video from the acquired images, the time length being set on a setting screen; and producing the video using the selected image.

A program according to an aspect of the present disclosure is a program that causes a computer to function as a processing unit that acquires an image to which metadata is added, selects, on the basis of a time length of video to be produced and the metadata, the image to be used for production of the video from the acquired images, the time length being set on a setting screen, and produces the video using the selected image.

In the image processing apparatus, the image processing method, and the program according to an aspect of the present disclosure, an image to which metadata is added is acquired, on the basis of a time length of video to be produced and the metadata, the image to be used for production of the video is selected from the acquired images, the time length being set on a setting screen, and the video is produced using the selected image.

Note that the image processing apparatus according to an aspect of the present disclosure may be an independent apparatus or an internal block constituting one apparatus.

### BRIEF DESCRIPTION OF DRAWINGS

FIG. 1 is a diagram showing a configuration example of an embodiment of a video production system to which the present disclosure is applied.

FIG. 2 is a block diagram showing a configuration example of a camera.

FIG. 3 is a block diagram showing a configuration example of a cloud server.

FIG. 4 is a block diagram showing a configuration example of a terminal apparatus.

FIG. 5 is a diagram showing a method of uploading an image from the camera to the cloud server.

FIG. 6 is a diagram showing a method of uploading a proxy image and a main image.

FIG. 7 is a diagram showing a first example of a sequence of uploading an image file.

FIG. 8 is a diagram showing a second example of the sequence of uploading an image file.

FIG. 9 is a flowchart describing the whole flow of a video production service.

FIG. 10 is a flowchart describing details of editing processing.

FIG. 11 is a diagram showing an example of presenting a shot mark.

FIG. 12 is a diagram showing an example of presenting information regarding movement of the camera.

FIG. 13 is a block diagram showing a functional configuration example of a processing unit in a video production system 1.

FIG. 14 is a diagram showing a first example of a setting screen.

FIG. 15 is a diagram showing a first example of an editing screen.

FIG. 16 is a diagram showing a second example of the setting screen.

FIG. 17 is a diagram showing an example of an aspect ratio.

FIG. 18 is a diagram showing an example of a standard time.

FIG. 19 is a diagram showing an example of a template.

FIG. 20 is a diagram showing a second example of the editing screen.

FIG. 21 is a diagram showing a first example of a file management screen.

FIG. 22 is a diagram showing a second example of the file management screen.

FIG. 23 is a diagram showing an example of a project registration screen.

FIG. 24 is a diagram showing a display example of a seventh region.

FIG. 25 is a diagram showing a third example of the setting screen.

FIG. 26 is a flowchart describing a flow of image selection processing and automatic editing processing.

FIG. 27 is a diagram showing an example of selection of an image for each group.

FIG. 28 is a diagram showing an example of a transition period.

### MODE (S) FOR CARRYING OUT THE INVENTION

### <System Configuration>

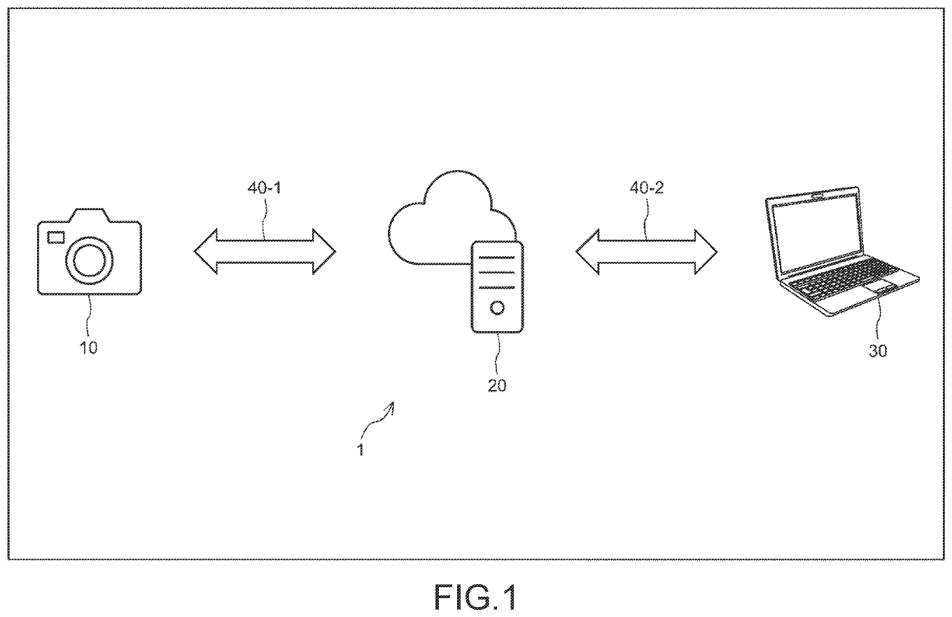

FIG. 1 is a diagram showing a configuration example of an embodiment of a video production system to which the present disclosure is applied.

A video production system 1 in FIG. 1 is a system for producing video from an image taken by a user. The video production system 1 includes a camera 10, a cloud server 20, and a terminal apparatus 30.

The camera 10 is a digital camera capable of taking video and a still image. The camera 10 is not limited to the digital camera and may be a device having an imaging function, such as a smartphone and a tablet terminal. The camera 10 takes a subject image in accordance with an operation of a user and records the resulting image.

The image includes content such as video and a still image. In the following description, in the case where it is necessary to distinguish video as an image and video automatically produced by a video production service from each other, the latter will be referred to as the produced-video.

The image taken by the camera 10 is transmitted to the cloud server 20. The camera 10 is capable of transmitting an image to the cloud server 20 via a network 40-1. Alternatively, the terminal apparatus 30 may transmit an image to the cloud server 20 via a network 40-2 by transferring the image from the camera 10 to the terminal apparatus 30 using a memory card such as a flash memory, wireless communication such as a wireless LAN (Local Area Network), wired communication conforming to a standard such as USB (Universal Serial Bus), or the like.

The network 40-1 and the network 40-2 each include a communication line such as the Internet and a mobile phone network. The network 40-1 and the network 40-2 may be the same network or different networks. Hereinafter, the network 40-1 and the network 40-2 do not need to be distinguished from each other, they are referred to as the network 40.

The cloud server 20 is a server that provides, via the network 40, a video production service for automatically producing the produced-video from an image. The cloud server 20 is an example of an image processing apparatus to which the present disclosure is applied. The cloud server 20 receives, via the network 40, the image taken by the camera 10. The cloud server 20 performs processing such as editing on the image to produce the produced-video and transmits the produced-video to the terminal apparatus 30 via the network 40. Further, the cloud server 20 generates a screen (e.g., a Web page) such as a setting screen and an editing screen and transmits the generated screen to the terminal apparatus 30 via the network 40.

The terminal apparatus 30 is a device such as a PC (Personal Computer), a tablet terminal, and a smartphone. The terminal apparatus 30 displays a screen (e.g., a UI (User Interface) of a Web browser) such as a setting screen and an editing screen transmitted from the cloud server 20 and performs processing such as setting relating to a video production service and editing of the produced-video in accordance with a user's operation on the screen. The terminal apparatus 30 receives the produced-video transmitted from the cloud server 20 via the network 40. The terminal apparatus 30 records the produced-video in the terminal or outputs the produced-video to the outside.

### <Configuration Example of Camera>

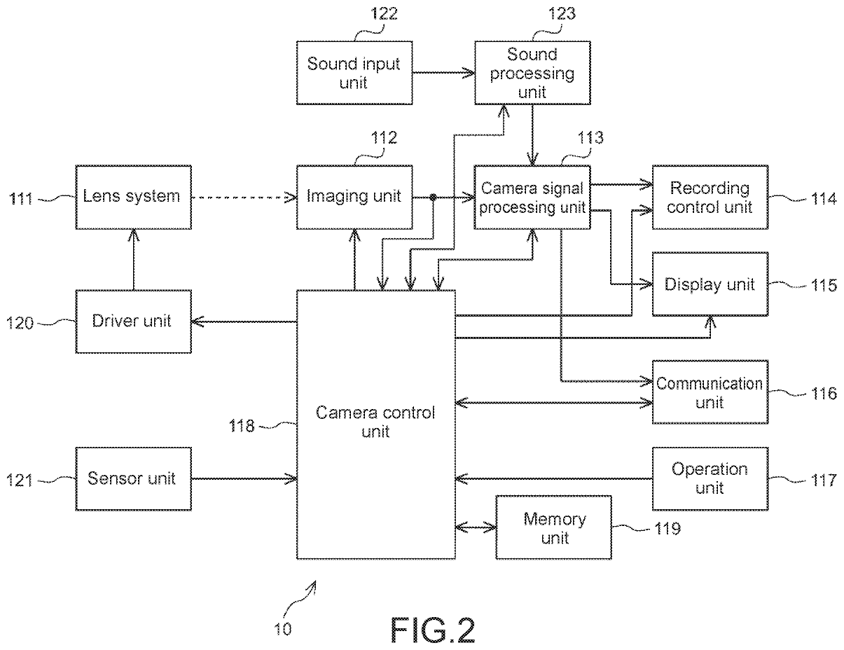

FIG. 2 is a block diagram showing a configuration example of the camera 10 in FIG. 1.

As shown in FIG. 2, the camera 10 includes a lens system 111, an imaging unit 112, a camera signal processing unit 113, a recording control unit 114, a display unit 115, a communication unit 116, an operation unit 117, a camera control unit 118, a memory unit 119, a driver unit 120, a sensor unit 121, a sound input unit 122, and a sound processing unit 123.

The lens system 111 takes in incident light (image light) from a subject and causes the light to enter the imaging unit 112. The imaging unit 112 includes a solid-state image sensor such as a CMOS (Complementary Metal Oxide Semiconductor) image sensor, converts the light amount of incident light imaged on an imaging surface of the solid-state image sensor by the lens system 111 into an electrical signal in pixel units, and outputs the electrical signal as a pixel signal.

The camera signal processing unit 113 includes a DSP (Digital Signal Processor), a frame memory that temporarily records image data, and the like. The camera signal processing unit 113 performs various types of signal processing on the image signal output from the imaging unit 112 and outputs the resulting image data of an image. In this way, the lens system 111, the imaging unit 112, and the camera signal processing unit 113 constitute an imaging system.

The recording control unit 114 records the image data of the image taken by the imaging system in a recording medium including a memory card such as a flash memory. The display unit 115 includes a liquid crystal display, an organic EL display, or the like, and displays the image taken by the imaging system.

The communication unit 116 includes a communication module or the like supporting a predetermined communication method such as wireless communication including a wireless LAN and cellular communication (e.g., 5G (5th Generation)), and transmits the image data of the image taken by the imaging system to another device via a network. The operation unit 117 includes an operation system such as a physical button and a touch panel and issues an operation command for various functions of the camera 10 in accordance with a user's operation.

The camera control unit 118 includes a CPU (Central Processing Unit) and a processor such as a microprocessor, and controls the operation of the respective units of the camera 10. The memory unit 119 records various types of data in accordance with the control from the camera control unit 118. The driver unit 120 drives the lens system 111 in order to realize autofocusing, zoom, and the like, in accordance with the control from the camera control unit 118.

The sensor unit 121 senses spatial information, time information, and the like, and outputs a sensor signal obtained as a result of the sensing. For example, the sensor unit 121 includes various sensors such as a gyro sensor and an acceleration sensor.

The sound input unit 122 includes a microphone or the like, detects a sound such as a user's voice and an environmental sound, outputs the resulting sound signal. The sound processing unit 123 performs sound signal processing on the sound signal output from the sound input unit 122. The sound signal from the sound processing unit 123 is input to the camera signal processing unit 113, is processed in synchronization with an image signal in accordance with the control from the camera control unit 118, and is recorded as sound (voice) of video.

In the camera 10 configured as described above, various types of metadata (camera metadata) can be added to an image including taken video and a taken still image. For example, in the imaging unit 112, in the case where an image plane phase difference pixel is disposed in a pixel region of a solid-state image sensor, information obtained by the image plane phase difference pixel can be added as metadata (image-plane-phase-difference-pixel information meta).

Information regarding autofocus by the camera control unit 118 and the driver unit 120 may be added as metadata (focus meta). In the sensor unit 121, information obtained from a sensor such as a gyro sensor can be added as metadata (gyrometa, etc.). In the sound processing unit 123, information regarding a device (microphone built in a camera, etc.) for inputting a sound signal, or the like can be added as metadata.

In the camera 10, a shot mark according to an operation of the operation unit 117 by a user may be added to an image including taken video and a taken still image. For example, in the case where a user wants to use an image being taken as an image to be used for a specific purpose (advertising video, etc.) at the time of imaging, a shot mark is added to the target image by operating the operation unit 117 including an operation system such as a button and a UI of a touch panel. The shot mark is a “sign” given by a user at a desired timing and can be said to be metadata added to an image.

Information regarding an image plane phase difference pixel, autofocus, a sensor, and a sound input device, and a shot mark are examples of the metadata to be added to the camera 10, and other information may be added as metadata as long as it is information processed inside the camera 10.

### <Configuration Example of Cloud Server>

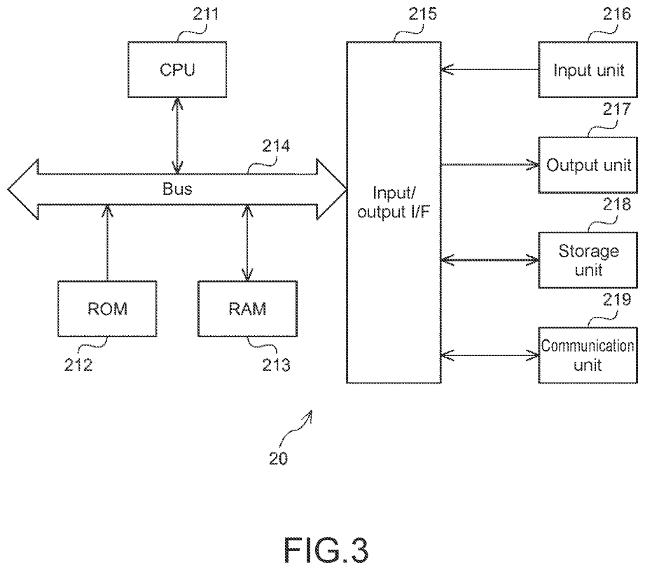

FIG. 3 is a block diagram showing a configuration example of the cloud server 20 in FIG. 1.

As shown in FIG. 3, in the cloud server 20, a CPU 211, a ROM (Read Only Memory) 212, and a RAM (Random Access Memory) 213 are connected to each other via a bus 214. An input/output I/F 215 is further connected to the bus 214. An input unit 216, an output unit 217, a storage unit 218, and a communication unit 219 are connected to the input/output I/F 215.

The input unit 216 supplies various input signals to the respective units including the CPU 211 via the input/output I/F 215. For example, the input unit 216 includes a keyboard, a mouse, a microphone, or the like.

The output unit 217 outputs various types of information in accordance with the control from the CPU 211 via the input/output I/F 215. For example, the output unit 217 includes a display, a speaker, or the like.

The storage unit 218 includes an auxiliary storage device such as a semiconductor memory and an HDD (Hard Disk Drive). The storage unit 218 records various types of data and a program in accordance with the control from the CPU 211. The CPU 211 reads various types of data from the storage unit 218, processes the read data, and executes a program.

The communication unit 219 includes a communication module or the like supporting wireless communication such as a wireless LAN and cellular communication (e.g., 5G) or wired communication. The communication unit 219 communicated with another device including the camera 10 and the terminal apparatus 30 via the network 40 in accordance with the control from the CPU 211.

Note that the configuration of the cloud server 20 shown in FIG. 3 is an example. For example, a dedicated processor such as a GPU (Graphics Processing Unit) may be provided to perform image processing.

### <Configuration Example of Terminal Apparatus>

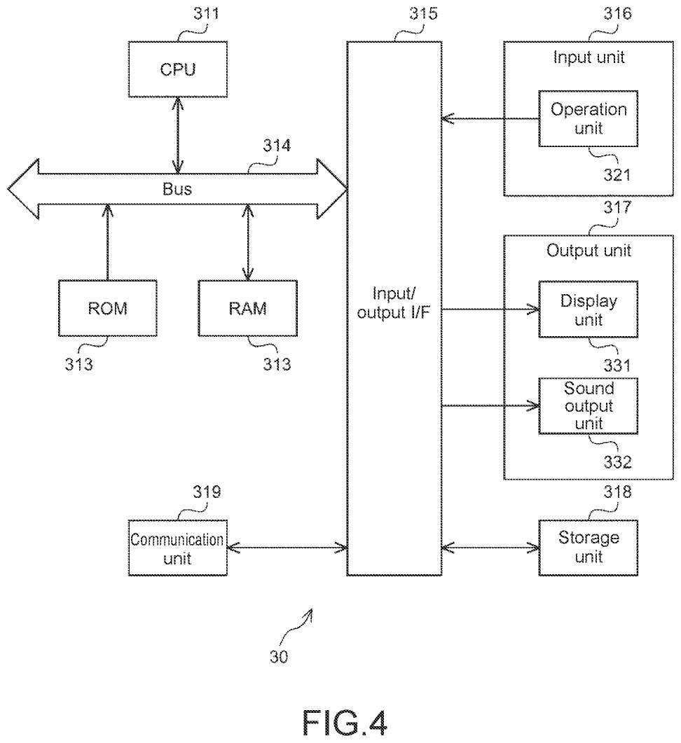

FIG. 4 is a block diagram showing a configuration example of the terminal apparatus 30 in FIG. 1.

As shown in FIG. 4, in the terminal apparatus 30, a CPU 311, a ROM 312, and a RAM 313 are connected to each other via a bus 314. An input/output I/F 315 is further connected to the bus 314. An input unit 316, an output unit 317, a storage unit 318, and a communication unit 319 are connected to the input/output I/F 315.

The input unit 316 supplies various input signals to the respective units including the CPU 311 via the input/output I/F 315. For example, the input unit 316 includes an operation unit 321. The operation unit 321 includes a keyboard, a mouse, a microphone, a physical button, a touch panel, or the like. The operation unit 321 is operated by a user and supplies an operation signal corresponding to the operation to the CPU 311.

The output unit 317 outputs various types of information via the input/output I/F 315 in accordance with the control from the CPU 311. For example, the output unit 317 includes a display unit 331 and a sound output unit 332.

The display unit 331 includes a liquid crystal display, an organic EL display, or the like. The display unit 331 displays an image, an editing screen, or the like in accordance with the control from the CPU 311. The sound output unit 332 includes a speaker, headphones connected to an output terminal, or the like. The sound output unit 332 outputs a sound corresponding to a sound signal in accordance with the control from the CPU 311.

The storage unit 318 includes an auxiliary storage device such as a semiconductor memory. The storage unit 318 may include an internal storage or may include an external storage such as a memory card. The storage unit 318 records various types of data and a program in accordance with the control from the CPU 311. The CPU 311 reads various types of data from the storage unit 318, processes the read data, and executes a program.

The communication unit 319 includes a communication module or the like supporting a predetermined communication method such as a wireless LAN and cellular communication (e.g., 5G) or wired communication. The communication unit 319 communicates with another device via a network in accordance with the control from the CPU 311.

Note that the configuration of the terminal apparatus 30 shown in FIG. 4 is an example. For example, a dedicated processor such as a GPU may be provided to perform image processing.

In the video production system 1 configured as described above, an image taken by the camera 10 is pulled out to the cloud server 20 and processing such as editing using the image and added metadata is performed to produce the produced-video. At this time, in the terminal apparatus 30, since information regarding the image, the produced-video, or the like on the cloud server 20 is displayed on a screen such as an editing screen, a user can edit the information.

Note that although a configuration in which one camera 10 and one terminal apparatus 30 are provided has been shown in the video production system 1 in FIG. 1 in order to simplify the description, one or more cameras 10 and one or more terminal apparatuses 30 are provided for each user who uses a video production service. The camera 10 and the terminal apparatus 30 may be operated by the same user or may be operated by different users. Although the cloud server 20 is installed in a data center or the like, the cloud server 20 may include a plurality of servers instead of one server to provide a video production service.

### <Method of Uploading Image>

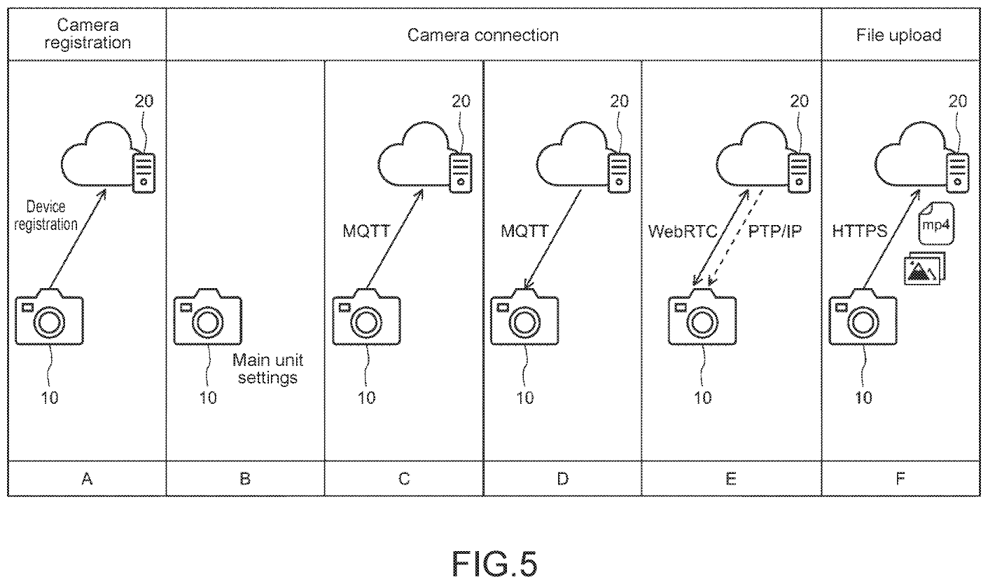

In the video production system 1, a file of an image taken by the camera 10 is uploaded to the cloud server 20 via the network 40 and is processed. For example, the file is uploaded by the method shown in FIG. 5.

FIG. 5 is a diagram showing a method of uploading an image from the camera 10 to the cloud server 20 by linking the camera 10 and the cloud server 20. Parts A to F of FIG. 5 show the exchange between the camera 10 and the cloud server 20 in chronological order. Between the camera 10 and the cloud server 20, three-stages of processing of camera registration, camera connection, and file upload are performed.

First, in the camera registration, the processing shown in Part A of FIG. 5 is performed. That is, the camera 10 is connected to the cloud server 20 via the network 40 in order to use a video production service and performs device registration in accordance with a user's operation or the like (Part A of FIG. 5).

Next, in the camera connection, the processing shown in Parts B to E of FIG. 5 is performed. That is, the camera 10 performs main unit settings in accordance with a user's operation or the like to turn on the cloud linkage and set the device registration to the completed state (Part B of FIG. 5). Further, the camera 10 notifies the cloud server 20 of the power-on (Part C of FIG. 5) using a communication protocol such as MQTT (Message Queuing Telemetry Transport).

The cloud server 20 that has received the notification from the camera 10 notifies the camera 10 of a command for transitioning to communication by WebRTC (Web Real-Time Communication) and a connection destination using a communication protocol such as MQTT (Part D of FIG. 5). As a result, communication by WebRTC is performed between the camera 10 and the cloud server 20 and a file upload destination using an image transfer protocol such as PTP-IP (Picture Transfer Protocol over TCP/IP networks) is provided (Part E of FIG. 5).

Next, in the file upload, the processing shown in Part F of FIG. 5 is performed. That is, the camera 10 is triggered by a request (PULL request) from the cloud server 20 to start uploading a file of an image including video and a still image via the network 40 (Part F of FIG. 5). At this time, a file to be uploaded from the side of the camera 10, such as a main image and a proxy image, can be selected on the side of the cloud server 20.

The camera 10 is capable of embedding metadata in an image to be uploaded. The cloud server 20 performs automatic selection, automatic trimming, automatic quality correction, and the like by processing using the metadata embedded in an image, thereby performing production of produced-video (automatic video production). During the file upload, it is possible to upload an image file more safely by using a protocol for performing communication requiring security, such as HTTPS (Hypertext Transfer Protocol Secure).

Here, the proxy image is an image having a resolution lower than that of a main image. When recording an image, the camera 10 is capable of simultaneously recording a main image that is an image having a high resolution and a proxy image that is an image having a low resolution. As a result, the camera 10 is capable of uploading a proxy image and a main image at different timings. That is, an image includes both a main image and a proxy image. For example, a main image and a proxy image are recorded for each of video and a still image.

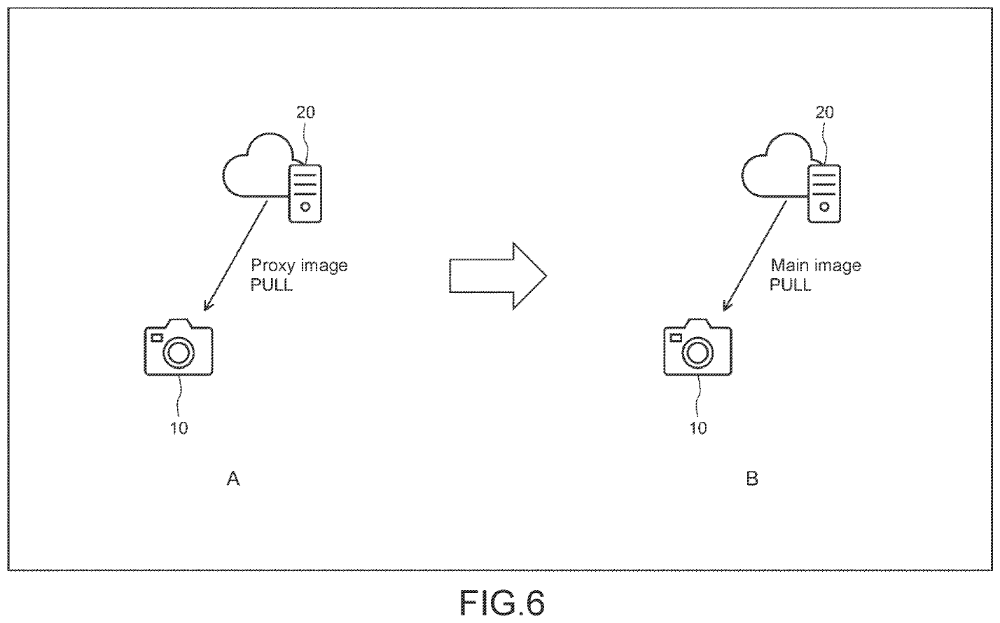

FIG. 6 is a diagram showing a method of uploading a proxy image and a main image. As shown in Part A of FIG. 6, when the cloud server 20 makes a PULL request for a proxy image, a file of a proxy image is uploaded from the camera 10. The cloud server 20 determines an image to be used for automatic video production using the uploaded file of a proxy image.

After that, as shown in Part B of FIG. 6, when the cloud server 20 makes a PULL request for a main image corresponding to the determined image, a file of a main image is uploaded from the camera 10. The cloud server 20 performs automatic video production using the uploaded file of a main image.

As described above, the cloud server 20 requests the camera 10 to upload a proxy image, pulls out only a proxy image first, determines an image to be used for automatic video production using the proxy image, then, requests the camera 10 to upload a main image, and thus is capable of pulling out a main image to be used for automatic video production later.

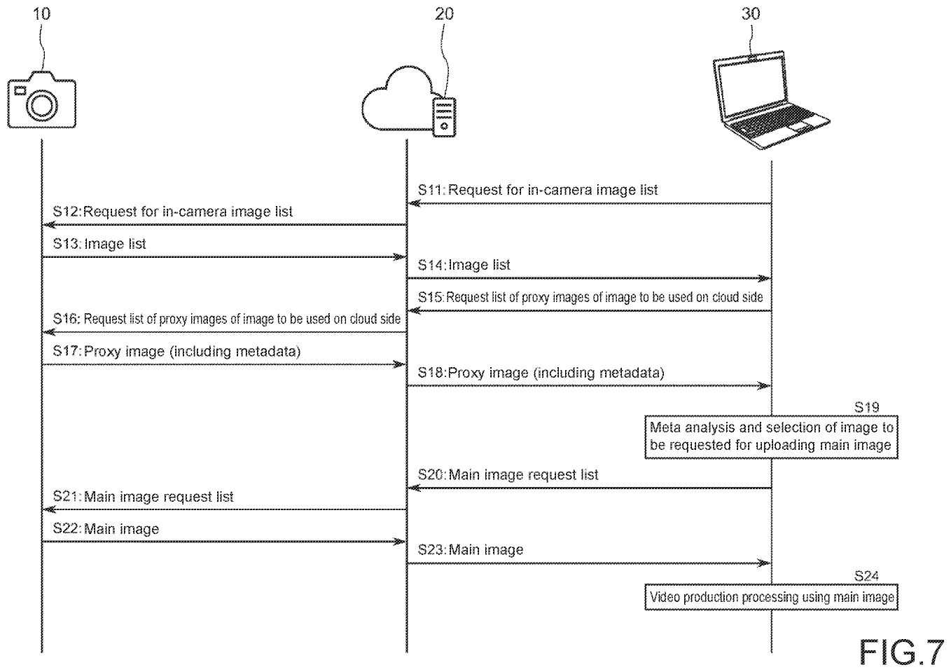

FIG. 7 is a diagram showing a first example of a sequence of uploading an image file.

As shown in FIG. 7, the terminal apparatus 30 an in-camera image list that is a list of images recorded in the camera 10 for the cloud server 20 via the network 40 (S11). The cloud server 20 requests the camera 10 for an in-camera image list via the network 40 on the basis of the request from the terminal apparatus 30 (S12).

The camera 10 receives a request from the cloud server 20 via the network 40 and transmits (returns) an image list corresponding to the request (S13). The cloud server 20 transmits (returns), to the terminal apparatus 30 via the network 40, the image list transmitted from the camera 10 (S14).

In the terminal apparatus 30, an image to be used for automatic video production by the cloud server 20 is selected from the image list transmitted from the cloud server 20. At this time, in the terminal apparatus 30, by presenting the image list, a desired image according to a user's operation can be selected. The terminal apparatus 30 transmits a request list of proxy images of an image to be used on the cloud side to the cloud server 20 via the network 40 (S15).

The cloud server 20 transmits, to the camera 10 via the network 40, the request list of proxy images transmitted from the terminal apparatus 30 (S16). The camera 10 receives the request list of proxy images from the cloud server 20 via the network 40 and uploads a proxy image corresponding to the list to the cloud server 20 (S17). Various types of metadata (camera metadata) are added to the proxy image.

In the cloud server 20, the file of a proxy image uploaded from the camera 10 is sequentially recorded on the storage unit 218. The cloud server 20 transmits, to the terminal apparatus 30 via the network 40, the proxy image uploaded by the camera 10 (S18).

In the terminal apparatus 30, metadata added to the proxy image from the cloud server 20 is analyzed and an image to be requested for uploading a main image is selected (S19). At this time, in the terminal apparatus 30, by presenting information regarding a proxy image and metadata, a desired image according to a user's operation can be selected. The terminal apparatus 30 transmits a main image request list to the cloud server 20 via the network 40 (S20).

The cloud server 20 transmits, to the camera 10 via the network 40, the main image request list transmitted from the terminal apparatus 30 (S21). The camera 10 receives the main image request list from the cloud server 20 via the network 40 and uploads a main image corresponding to the list to the cloud server 20 (S22). In the case where an image to be uploaded as a main image is video, the full scale or part of the scale of one video may be uploaded. That is, as a main image, the full scale or part of the scale of one video can be cut out and uploaded.

In the cloud server 20, a file of a main image uploaded from the camera 10 is sequentially recorded on the storage unit 218. The cloud server 20 transmits, to the terminal apparatus 30 via the network 40, the main image uploaded by the camera 10 (S23). As a result, in the terminal apparatus 30, video production processing such as editing processing using a main image is performed in cooperation with the cloud server 20 as necessary (S24).

Note that at the time of actual imaging, the following exchange may be performed between the camera 10 and the cloud server 20 via the network 40.

That is, at the time of imaging, the camera 10 may upload metadata of an image being taken to the cloud server 20, so that the cloud server 20 requests the camera 10 to upload a proxy image on the basis of the metadata before the end of imaging. Alternatively, at the time of imaging, the camera 10 may upload metadata of an image being taken and a proxy image to the cloud server 20, so that the cloud server 20 requests the camera 10 to upload a main image on the basis of the metadata and the proxy image before the end of imaging.

Although the sequence of uploading an image file has been shown above, another sequence may be used. For example, by transferring the image file recorded on the camera 10 to the terminal apparatus 30, the terminal apparatus 30 may upload the image file to the cloud server 20.

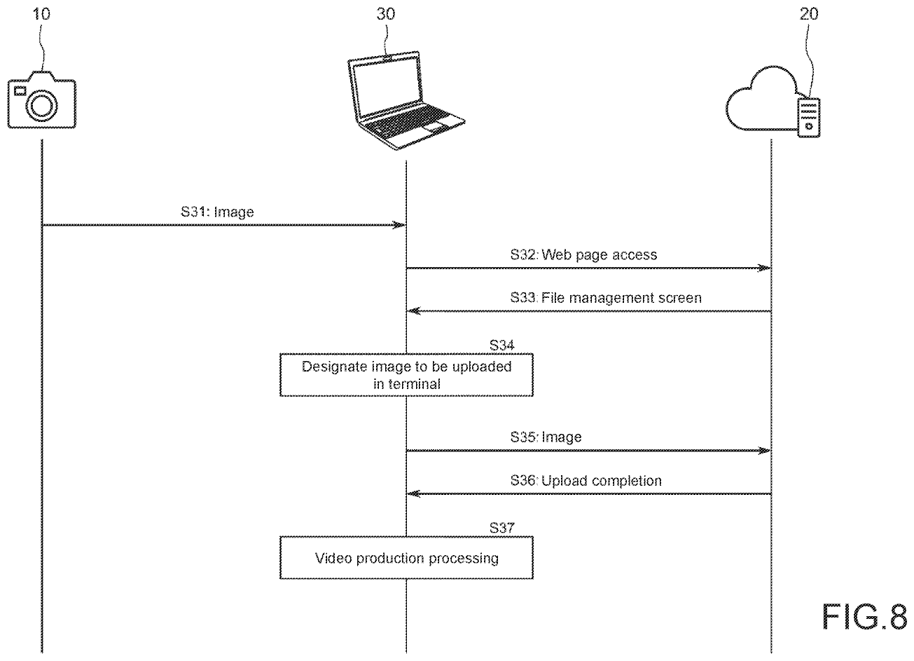

FIG. 8 is a diagram showing a second example of the sequence of uploading an image file.

As shown in FIG. 8, the camera 10 transfers an image to the terminal apparatus 30 (S31). The terminal apparatus 30 records a file of the transferred image on the storage unit 318. In this file transfer, a file of an image can be transferred using a memory card such as a flash memory, wireless communication such as a wireless LAN, or wired communication conforming to a standard such as USB.

The terminal apparatus 30 accesses a Web page provided by the cloud server 20 via the network 40 in accordance with location information such as URL (Uniform Resource Locator) (S32). The cloud server 20 transmits a file management screen via the network 40 in response to the access from the terminal apparatus 30 (S33).

In the terminal apparatus 30, the file management screen from the cloud server 20 is presented and a file of an image to be uploaded is designated from images in the terminal recorded on the storage unit 318 in accordance with a user's operation (S34). The terminal apparatus 30 uploads the designated image to the cloud server 20 via the network 40 (S35).

In the cloud server 20, the file of an image uploaded from the terminal apparatus 30 is sequentially recorded on the storage unit 218, and when the upload of an image is completed, the terminal apparatus 30 is notified of the completion of the upload via the network 40 (S36). As a result, in the terminal apparatus 30, video production processing such as editing processing using an image is performed in cooperation with the cloud server 20 as necessary (S37).

Note that although a main image and a proxy image have been described as images without being distinguished from each other in the sequence of FIG. 8, the proxy image and the main image may be processed in this order similarly as described above.

### <Overall Flow>

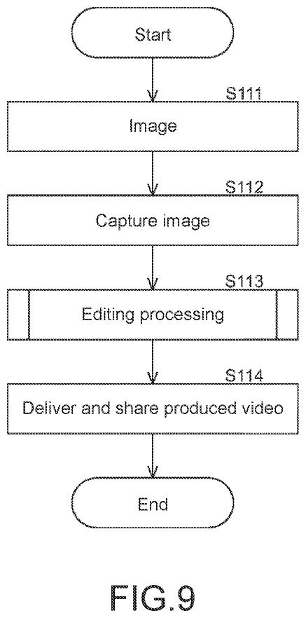

FIG. 9 is a flowchart showing a flow of a video production service provided by the video production system 1.

When using a video production service, the camera 10 performs imaging (S111), and the image such as video and a still image obtained by the imaging is uploaded to the cloud server 20 and captured (S112). The upload of an image file can be performed by, for example, one of the methods shown in FIG. 5 to FIG. 8.

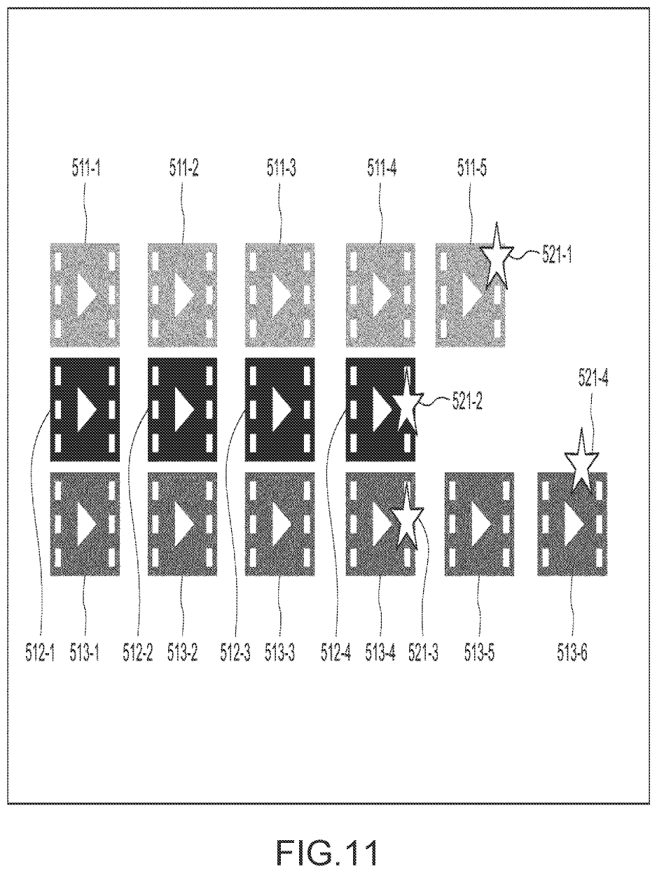

When an image is captured, in the cloud server 20, editing processing is performed (S113). In the editing processing, processing such as selection of a template to be used in automatic edition, automatic edition and manual edition of the image (clip), and sound processing is performed. Details of the editing processing will be described below with reference to the flowchart of FIG. 11. In the following description, an image captured in a device such as the cloud server 20 will be referred to also as a clip.

In the cloud server 20, by stitching videos obtained by automatic edition together in the editing processing, the final produced-video is produced and the produced-video is delivered and shared (S114).

For example, in a video production service, video production is performed in the following flow. That is, first, the cloud server 20 creates a project for managing information regarding video production in accordance with a user's operation and instructs the camera 10 to start capturing an image.

At this time, the cloud server 20 requests the camera 10 to upload a proxy image (PULL request) so that a proxy image of an image to which shot mark is added, of images taken by the camera 10, is captured, for example. As a result, in the cloud server 20, a proxy image from the camera 10 is captured (S112).

The cloud server 20 performs editing processing (S113), produces pre-produced-video from the captured proxy image, and delivers the video to the terminal apparatus 30 or the like via the network 40 to present the video to a user. In the editing processing here, in the case where an image is video, processing such as cutting out of an image frame near a shot mark, object recognition, and lively-voice recognition is performed and pre-produced-video corresponding to the processing is produced.

Next, the cloud server 20 requests the camera 10 to upload a main image (PULL request) so that only a main image of an image necessary for pre-produced-video is captured. As a result, in the cloud server 20, a main image from the camera 10 is captured (S112).

The cloud server 20 performs editing processing again (S113), and produces the final produced-video (completed video) from the captured main image. The produced-video thus produced is delivered to the terminal apparatus 30 or the like via the network 40 (S114) and is presented to a user.

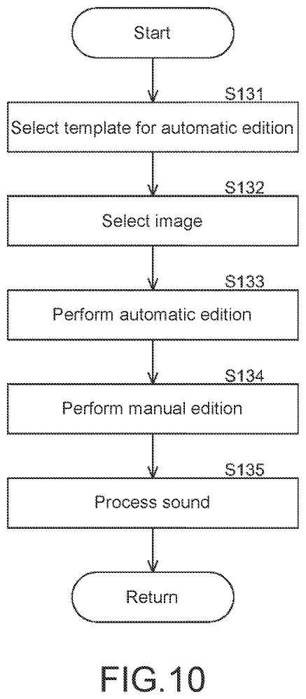

Here, details of the editing processing corresponding to Step S113 in FIG. 9 will be described with reference to the flowchart of FIG. 10.

In the editing processing, processing such as template selection processing (S131), image selection processing (S132), automatic editing processing (S133), manual editing processing (S134), and sound processing (S135) is performed.

In the template selection processing, a template to be used for automatic edition is selected in accordance with a user's operation (S131). By using the template, it is possible to produce the produced-video that reflects a user's intention with fewer steps. Details of a template will be described below.

In the image selection processing, an arbitrary image is selected (automatically selected or manually selected) from the captured images (S132). For example, in the image selection processing, a function of recognizing an image taken in the same scene using an AI technology and grouping the images recognized as the same is provided. That is, a selection function in the case where a plurality of images is taken for one scene is provided. Specifically, on the basis of image information and imaging time information obtained from each of the plurality of captured images, similar images can be grouped.

Using group information obtained by groping images, for example, it is possible to select one cut as an image to be used for produced-video from the same group to perform automatic edition and reduce the time and effort of manual edition by a user.

By providing such a selection function, for example, when a user repeatedly takes an image of the same or similar object or composition until a good image can be taken, it is possible to select, from images taken in the same scene, an image to be used for produced-video. Further, as an aid to manual selection of an image, images grouped for each scene may be presented. This makes it easier for a user to select, from images of the corresponding subject or composition, an image that he/she actually wants to use for produced-video.

Further, in the image selection processing, automatic selection and selection assistance of an image can be performed by performing the following processing. That is, in the case where an image is video, it is possible to preferentially extract and select, for example, a video clip containing the voice “OK” on the basis of the voice recorded during taking of the video. Further, automatic selection or assistance of manual selection of an image may be performed using a shot mark.

As assistance of manual selection of an image, for example, a viewer may be presented so that an image to which a shot mark is added can be recognized in accordance with a user (photographer)'s operation at the time of imaging as shown in FIG. 11. For example, a shot mark is added to an image recommended by a user for use in advertisement. The viewer can be displayed on the terminal apparatus 30.

In FIG. 11, of images 511-1 to 511-5 grouped in the same group, the image 511-5 is given a shot mark 521-1. Similarly, of images 512-1 to 512-4 grouped in the same group, the image 512-4 is given a shot mark 521-2. Further, of images 513-1 to 513-6 grouped in the same group, the images 513-4 and 513-6 are respectively given shot marks 521-3 and 521-4.

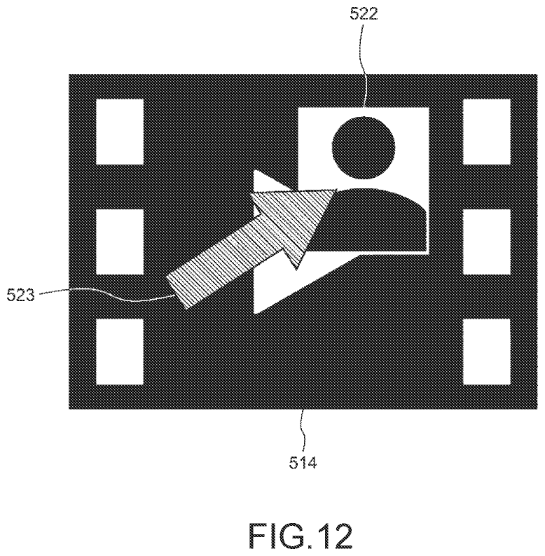

Further, as assistance of manual selection of an image, information (gyrometa, etc.) regarding movement of the camera 10 may be used to visualize camera work on a viewer. For example, as shown in FIG. 12, in the camera 10, a face region included in the image can be cut out using a parameter (face frame parameter) regarding a frame superimposed on a face portion of a human detected at the time of imaging to perform image processing of adding camera work such as panning and zooming. The face frame metadata is metadata including an in-focus position of a face or the like and a size.

In FIG. 12, a face frame 522 is superimposed on a face region included in an image 514, and, for example, information indicating that the camera 10 has zoomed in or zoomed out or information indicating that the camera 10 has been swung to the left or right is displayed by camera work information 523 shown by an arrow in the figure.

In the case where an image is video, information regarding a position where sound (voice) is contained may be visualized. For example, analysis processing for analyzing sound of video can be performed to display a mark indicating a period containing sound on the timeline of video displayed on an editing screen. Alternatively, so-called automatic voice transcription function or the like may be used to display character information based on the dialogue of a speaker. Recognition processing for recognizing an object included in an image may be performed to extract and display an image including a desired object. For example, by performing face recognition processing on an image, it is possible to extract an image in which a specific person (e.g., Mr./Ms. A) appears.

In the automatic editing processing, automatic edition using the image selected in the image selection processing is performed (S133). For example, in the automatic editing processing, processing such as automatic trimming of performing automatic selection of an in point and an out point of video and automatic quality correction of performing correction for improving the quality of an image (clip) is performed. For example, in the automatic quality correction, camera shake removing processing using information (gyrometa, etc.) regarding movement of the camera 10 is performed to remove the influence of camera shake from an image. Alternatively, processing such as panning and zooming by recognizing a main subject using focus meta may be performed.

By taking video with HFR (High Frame Rate) at the time of imaging, slow motion processing can be performed in the editing processing after imaging. In the processing, an AI technology, image processing, or the like may be used to interpolate an image frame. At the time of imaging, for example, processing of cutting out an image (clip) of a main scene can be performed using a shot mark added to an image.

Alternatively, correction processing may be performed on an image using metadata added to an image at the time of imaging or an AI technology. For example, the metadata can include information regarding WB (White Balance) and brightness. As the correction processing, correction relating to WB, exposure, and LUT (Lookup Table) between a plurality of images can be performed. The LUT is a table used when converting colors or the like.

Processing for making the brightness and hue of an image uniform may be performed on the basis of editing information obtained by editing processing on an image. That is, the brightness and hue of an image differs depending on a subject, a light condition, or the like at the time of imaging. In order to avoid such a situation, at the time point when an image to be used for producing produced-video (completed video) was determined, correction processing for making the brightness and hue of a target image uniform is performed.

As a result, it is possible to reduce the sense of discomfort when a user views the produced-video and improve the degree of completion of the produced-video. In the case where such correction processing is not performed automatically, a user who has knowledge of editing would perform this manually, which takes time and effort. The correction processing makes it possible for a user who has knowledge of editing to save labor by automation and for a user who does not have knowledge of editing to do something that he/she was not able to do until now.

In the manual editing processing, editing processing relating to produced-video that is an image selected by the image selection processing and produced by the automatic edition is performed in accordance with a user's operation (S134). Here, a user can instruct editing processing on the produced-video by operating a UI of an editing screen displayed on the terminal apparatus 30. For example, additional editing such as replacing with his/her favorite video or still image and changing the cut out time is performed as necessary on the produced-video produced by the automatic edition. Note that in the case where the user determines that the produced-video does not need to be edited, it is unnecessary to perform manual editing processing.

In the sound processing, processing relating to sound processing of produced-video is performed (S135). For example, wind noise reduction processing by an AI technology, sound signal processing, or the like can be performed using device characteristic information of a microphone built in a camera as the sound input unit 122 of the camera 10. As a result, it is possible to remove the noise such as wind noise as sound of movie and make the utterance volume of a person uniform.

The wind noise is annoying to a viewer of video and it is necessary to attach a windjammer accessory in order to take video such that wind noise is not recorded at the time of imaging, which takes time and effort for the user. Further, in the case where wind noise is recorded at the time of imaging, specialized editing such as using an equalizer is necessary in order to manually remove the wind noise. In the sound processing, since noise such as wind noise is automatically removed from video at the time of editing an image, a user can easily remove the noise without performing any operation.

When video is taken by the camera 10, the distance between a person and a microphone differs depending on the imaging location or the distance between a person and a microphone changes depending on the position of the person even in the case where persons take video at the same time, which changes the utterance volume in some cases. In such a case, in order to make the volume uniform, typically, time-consuming editing such as adjusting the volume individually by using a separate channel with a microphone or storing as a separate audio file for each speaker is necessary. In the sound processing, it is possible to automatically make the utterance volume between a plurality of files uniform and make the volume uniform after separating the voices of a plurality of speakers even within the same audio channel of the same file. As a result, a user can easily produce video in which the sound is easy to hear.

When the processing of Step S135 is finished, the processing returns to Step S113 in FIG. 9 and the processing of Step S113 and subsequent Steps is executed.

Note that the editing processing described in the flowchart in FIG. 10 is an example and other processing may be executed. For example, processing of changing the in-focus position after imaging using image-plane-phase-difference-pixel information meta may be performed. Further, in the case where a ranging sensor is provided as the sensor unit 121, processing relating to XR (Extended Reality) using depth information obtained by the ranging sensor may be performed.

Metadata indicating in-focus coordinate information when taking an image by the camera 10 and recognition processing of an object name, a person name, and the like in an image by the cloud server 20 may be combined with each other. As a result, it is possible to convert the name of an object or person focused at the time of imaging into character information and display the character information as auxiliary data of manual selection of an image.

in the case where an image is video, after recognizing, by voice recognition processing, in-video sound recorded by the main unit of the camera 10 and separately-recorded sound separately recorded by a recorder such as an IC recorder and a PCM recorder for a position where sound is contained in video, the sound (voice) may be synchronized with each other with reference to the time when the same word is uttered.

By learning the WB, exposure, and the like manually adjusted by a creator by machine learning to generate a trained model (e.g., DNN (Deep Neural Network)), the trained model can be used to perform correction (automatic quality correction) of the WB, exposure, and the like on an image in the subsequent production. Further, even if a plurality of people works using the trained model or the work is taken over, it is possible to continuously perform the same correction of the WB, exposure, and the like. In this way, each user can use a trained model learned by using the created data of a creator as learning data.

In the video production system 1, a series of user's operations for realizing video editing is provided as a system. In general, it is necessary to select a suitable image and perform a plurality of editing operations in combination in video editing, and it is difficult for a user to learn the editing technique. In the video production system 1, for example, by following the procedures (a) to (e) below, even a user who has no or little knowledge of video editing can easily perform video editing to produce desired produced-video.

(a) Determine a template of information such as music, font, and hue that determine the atmosphere of video and the time length of produced-video (completed video).

(b) Upload video, a still image, sound (voice), an LUT file.

(c) Press an automatic creation button of a screen such as an editing screen.

(d) Perform manual edition such as replacing with a favorite video or still image and changing the cut out time as necessary.

(e) In accordance with the replaced video or still image, the brightness and hue are corrected again as necessary and correction processing such as camera shake correction, wind noise reduction, and making the utterance volume uniform is executed in addition thereto to produce produced-video (completed video).

### <Functional Configuration Example>

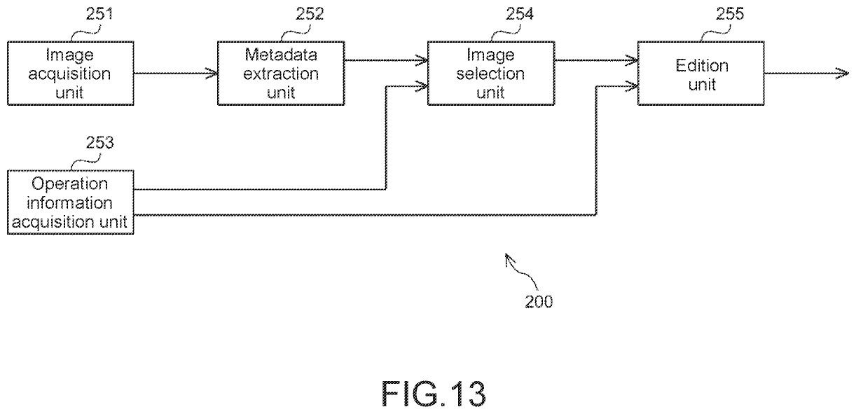

FIG. 13 is a block diagram showing a functional configuration example of a processing unit 200 in the video production system 1. For example, the processing unit 200 is realized by executing a program such as a video production program by a processor such as the CPU 211 and the GPU of the cloud server 20. Alternatively, the processing unit 200 may be realized as a dedicated circuit.

In FIG. 13, in the processing unit 200, processing such as selection and editing using an image is performed to produce produced-video. The processing unit 200 includes an image acquisition unit 251, a metadata extraction unit 252, an operation information acquisition unit 253, an image selection unit 254, and an edition unit 255.

The image acquisition unit 251 acquires the image uploaded from the camera 10 or the terminal apparatus 30 via the network 40 and supplies the image to the metadata extraction unit 252.

The metadata extraction unit 252 extracts the metadata added to the image supplied from the image acquisition unit 251 and supplies the metadata to the image selection unit 254 together with the image. In the case where an image to which no metadata has been added is supplied to the metadata extraction unit 252, the image is supplied as it is to the image selection unit 254.

The operation information acquisition unit 253 acquires operation information regarding an operation of a screen such as a setting screen and an editing screen, which is transmitted from the terminal apparatus 30 via the network 40, and supplies the operation information to the image selection unit 254 or the edition unit 255.

The metadata and the image from the metadata extraction unit 252 and the operation information from the operation information acquisition unit 253 are supplied to the image selection unit 254. The image selection unit 254 selects, on the basis of the operation information and the metadata, an image to be used for production of produced-video from images, and supplies the selected image to the edition unit 255.

For example, the operation information includes information indicating the time length of produced-video set by a setting screen. The metadata includes camera metadata added to an image by the camera 10 at the time of imaging. More specifically, the metadata includes a shot mark added to an image in accordance with a user's operation. As will be described in detail later, the image selection unit 254 is capable of select, on the basis of the time length of produced-video and the shot mark, an image to be used for production of the produced-video.

The edition unit 255 produces produced-video by performing automatic editing processing including processing such as automatic trimming and automatic quality correction using the selected image supplied from the image selection unit 254. As will be described in detail later, in the automatic quality correction, correction processing such as brightness correction and hue correction can be performed. Further, in the case where editing information set on an editing screen is supplied from the operation information acquisition unit 253 as operation information, the edition unit 255 is capable of performing automatic editing processing using the editing information. For example, the produced produced-video is delivered to the terminal apparatus 30 via the network 40 or shared on the network 40.

### <First Example of Setting Screen>

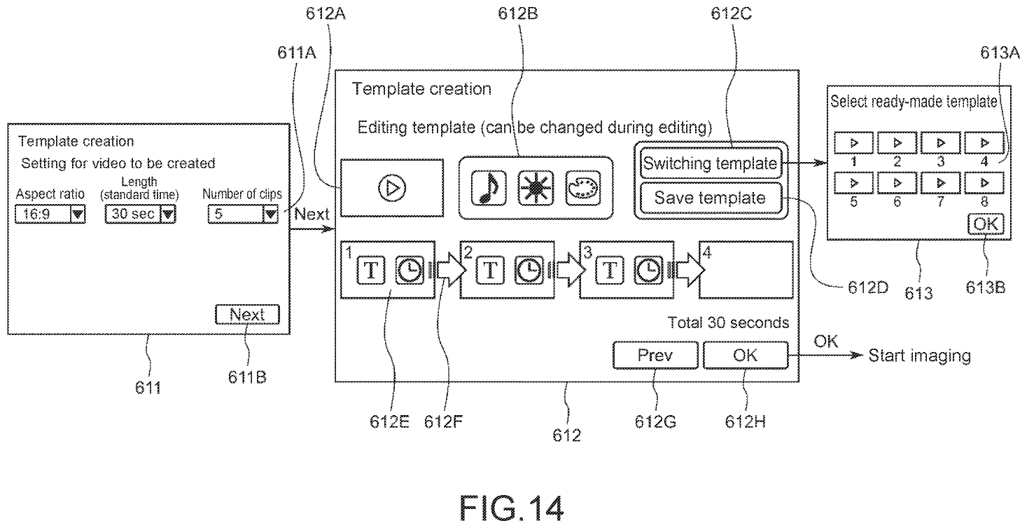

FIG. 14 is a diagram showing a first example of a setting screen used before imaging. For example, the setting screen is displayed on the display unit 331 of the terminal apparatus 30.

In FIG. 14, in a setting screen 611, an aspect ratio, a time length (standard time), and the number of clips (number of images) can be set as a production condition 611A when the cloud server 20 produces produced-video. A storyboard (frame thereof) relating to produced-video is generated on the basis of the aspect ratio, the time length, and the number of clips set by the setting screen 611.

In the case where a next button 611B has been pressed, the screen transitions from the setting screen 611 to a setting screen 612. In FIG. 14, in the setting screen 612, settings relating to a template are made. For example, editing of a template corresponding to the storyboard can be performed.

On the setting screen 612, a playback region 612A for playing back sample video, a setting region 612B for setting music used in produced-video and the brightness, color, and the like of the produced-video, a switching button 612C to be operated when switching a template, and a save button 612D to be operated when saving a template are displayed.

In the case where the switching button 612C has been pressed, the screen transitions from the setting screen 612 to a selection screen 613. In the selection screen 613, a template to be used can be switched by selecting a desired template from a ready-made template group 613A and pressing an OK button 613B. In the case where the save button 612D has been pressed, the content of the template displayed on the setting screen 612 is saved.

On the setting screen 612, a setting region 612E for setting the character insertion scale or the like for each image (clip), switching information 612F indicating the switching effect between images (clips), a preview button 612G to be operated when checking the content when a template is applied, and an OK button 612H to be operated when determining a template are further displayed.

In the case where the OK button 612H has been pressed, the content of a template displayed on the setting screen 612 is set and used at the time of video production. When a user performs such a setting operation and then starts taking an image by the camera 10, processing according to the template is performed on the image obtained by the imaging and produced-video is produced. In this way, by setting a template in advance by a user, the image and video production are linked, which makes the work of video production easier.

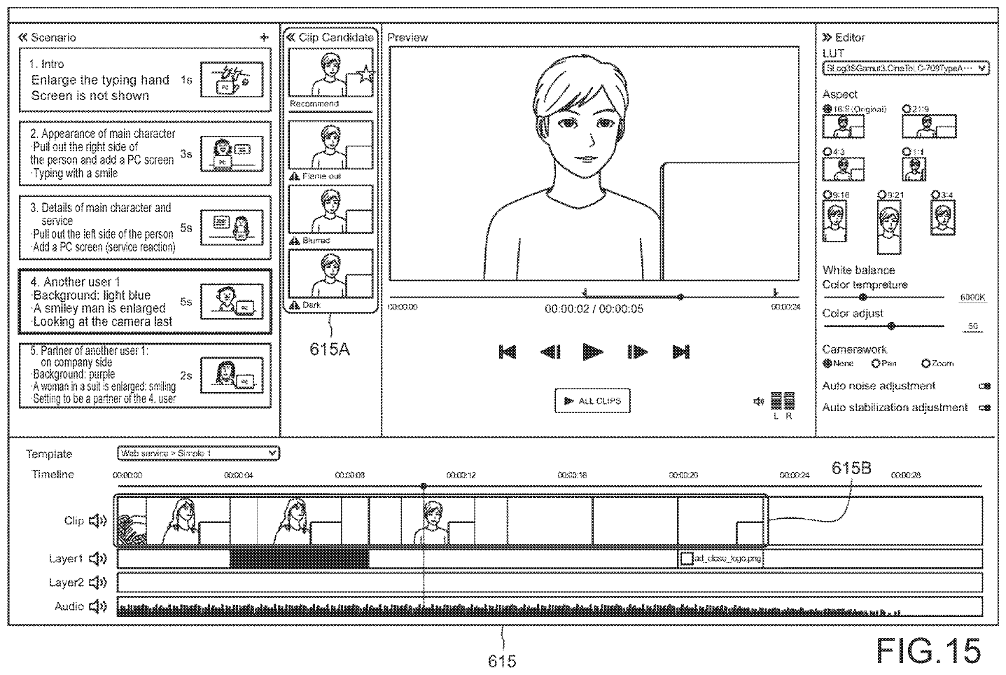

Further, in the video production, after performing automatic edition such as automatic selection, automatic trimming, and automatic quality correction, manual edition according to a user's operation can be performed as appropriate. For the manual edition, for example, the editing screen shown in FIG. 15 can be used. For example, the editing screen is displayed on the display unit 331 of the terminal apparatus 30.

### <First Example of Editing Screen>

In an editing screen 615 in FIG. 15, various types of information regarding produced-video obtained by performing automatic edition on the image taken after settings are displayed in accordance with the content of the template set in advance in the setting screens 611 and 612 in FIG. 14. The various types of information displayed on the editing screen 615 can be manually edited in accordance with a user's operation.

For example, in the editing screen 615, an image (clip) selected for the storyboard at the time of template setting is displayed in a first region 615A. In the case where a shot mark is added to a target image, information indicating a shot mark may be superimposed thereon. Correction processing such as camera shake and sound processing has been applied to the image (clip) displayed in the first region 615A. Further, correction processing has been applied to the image (clip) displayed in a second region 615B in chronological order such that the brightness and hue are made constant.

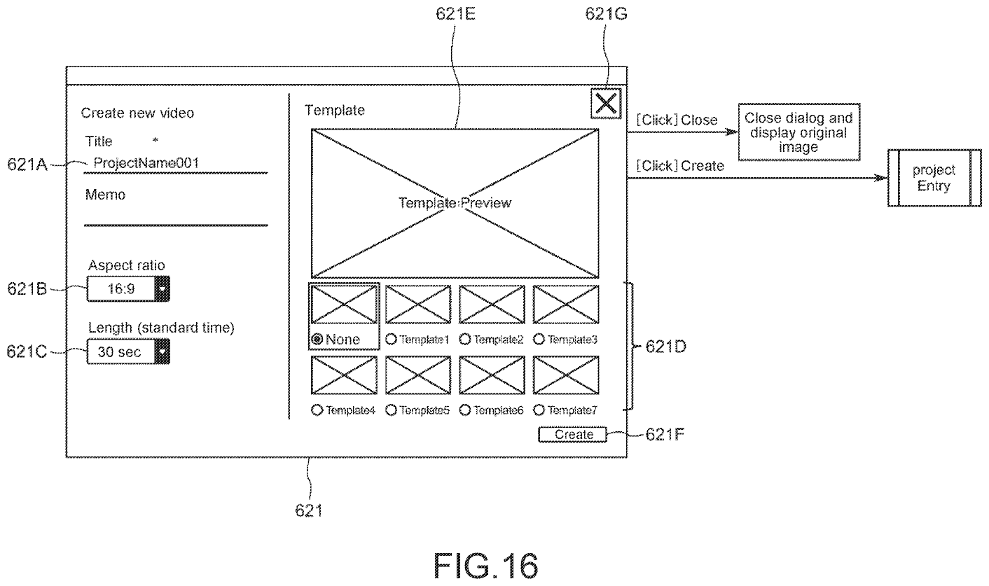

In this way, by setting a template in advance, it is possible to produce produced-video to which the content of the template has been applied. Alternatively, the standard time of produced-video and the template may be set using the setting screen as shown in FIG. 16.

### <Second Example of Setting Screen>

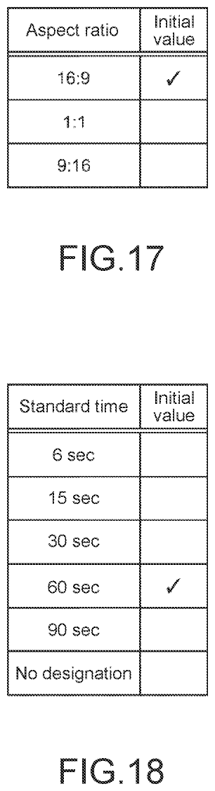

FIG. 16 is a diagram showing a second example of the setting screen to be used at the time of video production. In the description of the setting screen of FIG. 16, description will be made with reference to tables in FIG. 17 to FIG. 19 as appropriate.

In FIG. 16, a setting screen 621 includes a title designation section 621A for designating a title of a project, or the like, an aspect ratio designation section 621B for designating the aspect ratio of produced-video, and a standard time designation section 621C for designating the time of produced-video. The setting screen 621 further includes a template selection section 621D for selecting a desired template, a template display section 621E for displaying the selected template, and a creation button 621F for instructing to create a project.

In the title designation section 621A, the tile of produced-video or a project, a memo relating to the produced-video or the project, and the like are input in accordance with a user's operation.

In the aspect ratio designation section 621B, the aspect ratio of produced-video is designated in accordance with a user's operation. For example, as shown in FIG. 17, an aspect ratio such as 1:1 and 9:16 can be selected as an initial value. In recent years, a smartphone, a tablet terminal, and the like have been used as a device for viewing video in addition to a television receiver, and video is increasingly displayed and viewed as part of a UI of an SNS (Social Networking Service) or a Web site. In this regard, the aspect ratio of produced-video can be changed by a user in accordance with an environment in which he/she wants to perform distribution, or the like.

Note that as will be described in detail later, the aspect ratio of produced-video set by the aspect ratio designation section 621B of the setting screen 621 can be changed later. For videos that do not match the aspect ratio, setting regarding whether to cut out the angle of view so that part of the video can be seen or superimpose a black belt region so that the entire video can be seen can be performed.

In the standard time designation section 621C, how many seconds the time length of produced-video should be is designated in accordance with a user's operation. For example, as shown in FIG. 18, a standard time such as 6 seconds, 15 seconds, 30 seconds, and 90 seconds can be selected with 60 seconds as an initial value. The standard time does not necessarily need to be set.

In the template selection section 621D, information regarding one or more templates is displayed and one template can be selected by a radio button or the like. A user can easily change the atmosphere of video to his/her taste by simply selecting one desired template from templates displayed in the template selection section 621D.

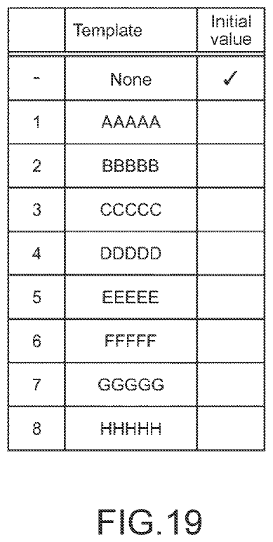

For example, as shown in FIG. 19, one of templates 1 to 8 can be selected with “no template” as an initial value and the name and other setting information have been registered for each template that can be set. For example, for each template, information such as each cut time of video, hue, transition of cut switching, BGM, a position and a character size at the time of subtitle superposition, and a font has been registered.

In the template display section 621E, the template selected in the template selection section 621D is preview-played. By causing a user to view completed sample video when the designated template has been applied to video, he/she can intuitively recognize the image of produced-video (completed video).

Note that although setting information of a template and the like can be changed after editing work, editable portions can be allocated, e.g., a portion where editing work by a user, such as the cut time, is prioritized is made uneditable.

The creation button 621F is a button for instructing the entry of a project. In the case where the creation button 621F has been pressed by a user, a project for producing produced-video corresponding to the set content is registered. In the case where a close button 621G has been pressed, the setting screen 621 is closed and the caller's screen is displayed.

### <Second Example of Editing Screen>

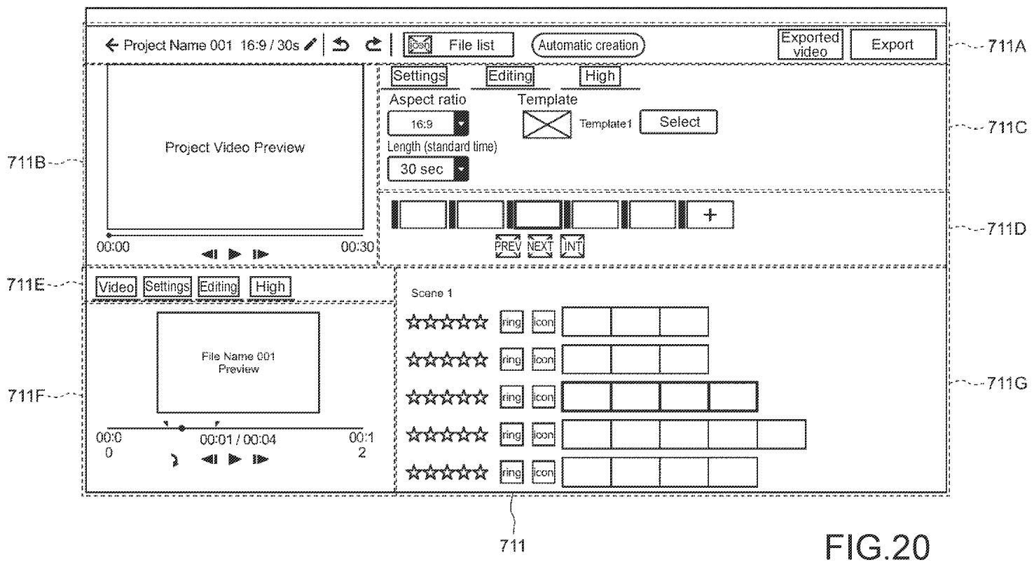

FIG. 20 is a diagram showing a second example of the editing screen to be used at the time of video editing.

An editing screen 711 includes a first region 711A for receiving a user's operation, a second region 711B for performing preview-play of video, a third region 711C for performing settings relating to editing, and a fourth region 711D for performing timeline editing and transition setting. The editing screen 711 further includes a fifth region 711E and a sixth region 711F for performing an editing operation on a target image, and a seventh region 711G for displaying a list of uploaded images or the like.

The first region 711A is a region in which a button or the like for receiving a user's operation of instructing to execute production of produced-video, correction, export, and the like is disposed. For example, in the case where the brightness, the hue, the volume difference of the uttered sound are desired to be made constant again by replacing images to be used for produced-video, these functions are executed when an automatic creation button is pressed by a user's operation. Note that not at the timing when an automatic creation button was pressed but when or at the moment when an operation was performed by a user, the function corresponding to the operation may be executed. In the case where produced-video is desired to be output, an export button is pressed.

The second region 711B is a region in which preview play of the timeline editing performed in the fourth region 711D is performed. The third region 711C is a region for performing editing settings of the entire produced-video, or the like. For example, in the third region 711C, the brightness and hue of the entire produced-video can be changed and BGM can be changed. Further, in the third region 711C, the aspect ratio of produced-video and the time length (standard time) of produced-video can be changed.

The fourth region 711D is a region in which cut replacement of the timeline editing, transition setting, and the like are performed. For example, even after the automatic creation button is pressed to execute automatic edition, a user can add or delete an image to be included in the timeline, change the order, and change the transition effect of switching using the fourth region 711D.

The fifth region 711E and the sixth region 711F are regions for performing an editing operation on a target image. In the sixth region 711F, the start/end time of the time cut out from one video can be changed in the case where an image is the video, and the length of the time for displaying one still image can be changed in the case where an image is the still image.

The seventh region 711G is a region in which a list of images uploaded to or registered in a project is displayed. A user can register a file of an image such as video and a still image, sound (voice), and the like in a project using a file management screen.

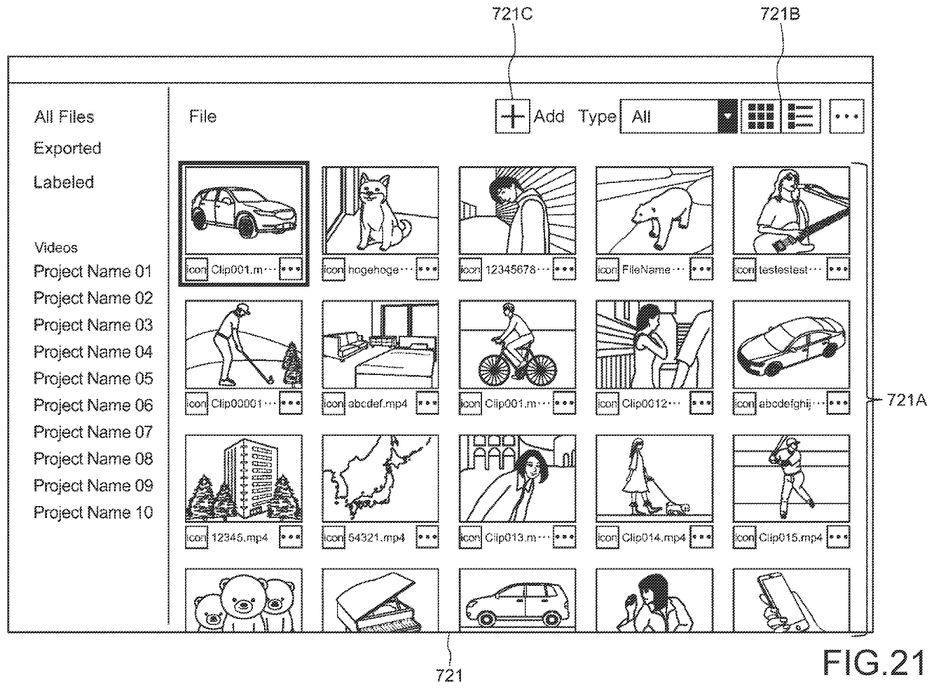

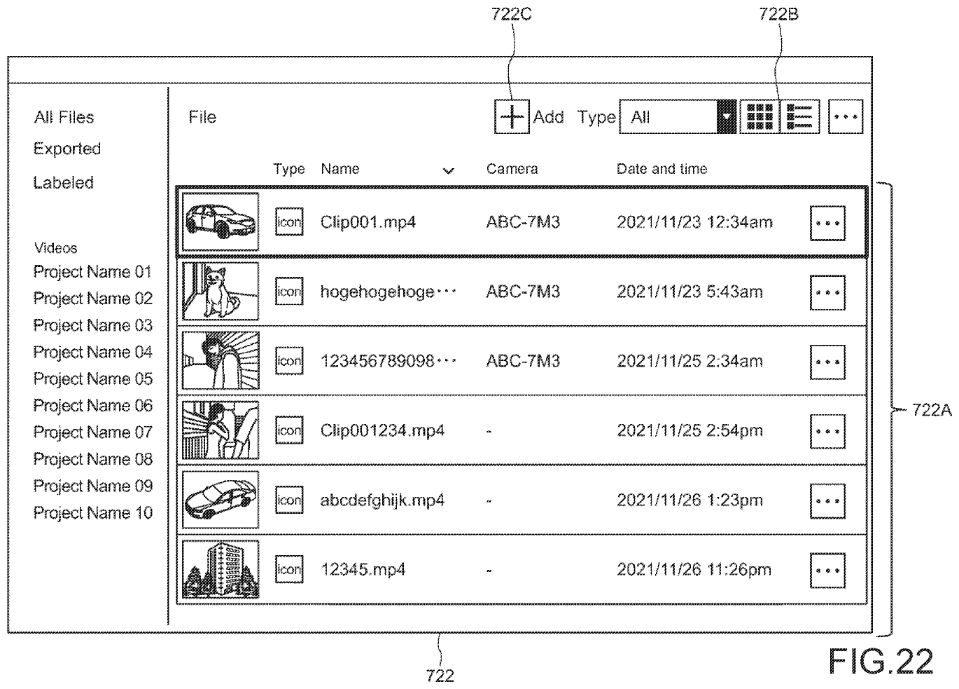

FIG. 21 and FIG. 22 are each a diagram showing an example of a file management screen. In a selection region 721A of a file management screen 721 in FIG. 21, a thumbnail image is displayed for each image such as video and a still image. In a selection region 722A of a file management screen 722 in FIG. 22, a list of images such as video and a still image is displayed.

Such thumbnail and list display can be switched by operating a switching button 721B or a switching button 722B. A user can register a desired image in a desired project by selecting the desired image using the file management screen 721 or the file management screen 722 and pressing an add button 721C or an add button 722C.

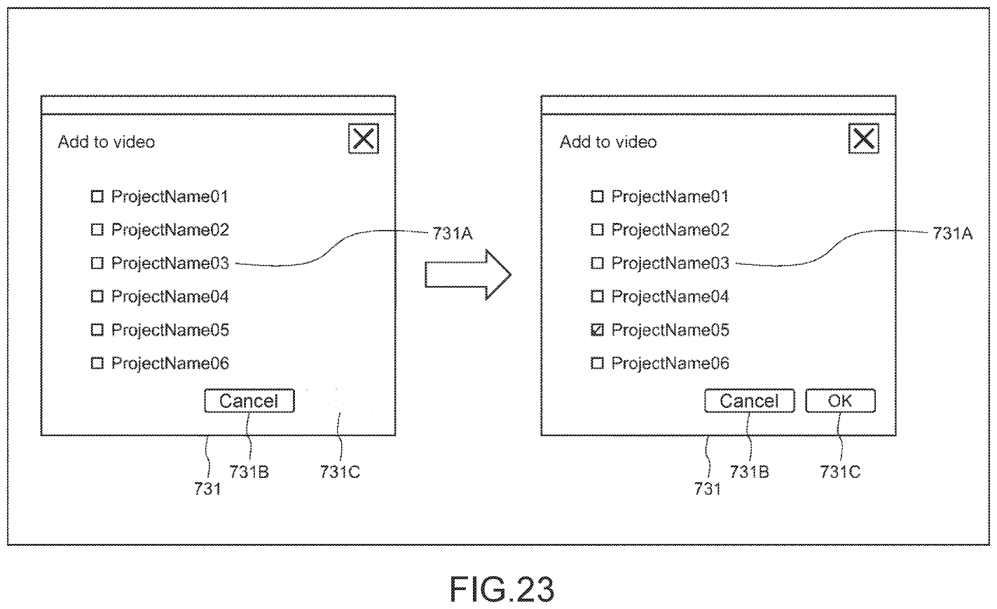

FIG. 23 is a diagram showing an example of a project registration screen. A user can register a desired image in a desired project by selecting the desired project from a project list 731A displayed in a project registration screen 731 and pressing an OK button 731C. Note that in order to cancel the registration to a project, it only needs to press a cancel button 731B.

For example, when an image is uploaded to the cloud server 20, the image can be registered in a project at the same time. At this time, the image may be registered in a project using the project registration screen 731. Alternatively, an image uploaded in advance may be registered in a project using the project registration screen 731.

The image registered in a project is displayed in a list in the seventh region 711G in the editing screen 711. In the seventh region 711G, in the case where the image registered in a project is video, for example, image frames corresponding to the times at regular intervals, such as the times at 0, 5, and 10 seconds, are displayed. As a result, a user can recognize the whole picture of video registered in a project. Although a screen relating to registration of a sound file is not illustrate, a UI capable of selecting a sound file is provided separately from a file management screen for an image shown in FIG. 21 and FIG. 22 and a sound file displayed in a list can be selected and registered in a project.

In the case where a user has uploaded a file of video, a still image, or sound (voice), then, he/she can execute production of produced-video by pressing the automatic creation button of the first region 711A. Incidentally, at the time of imaging by the camera 10, when a user takes an image of a certain subject, it is generally common to repeatedly take images twice or three times because he/she cannot take an image well at first.

In this regard, as processing to be performed when the automatic creation button of the first region 711A was pressed, processing of grouping images having similar features and close imaging times by extracting feature amounts of images using an AI technology and taking into consideration of information regarding the time when the image was taken is performed. The images grouped in this way can be displayed in the seventh region 711G.

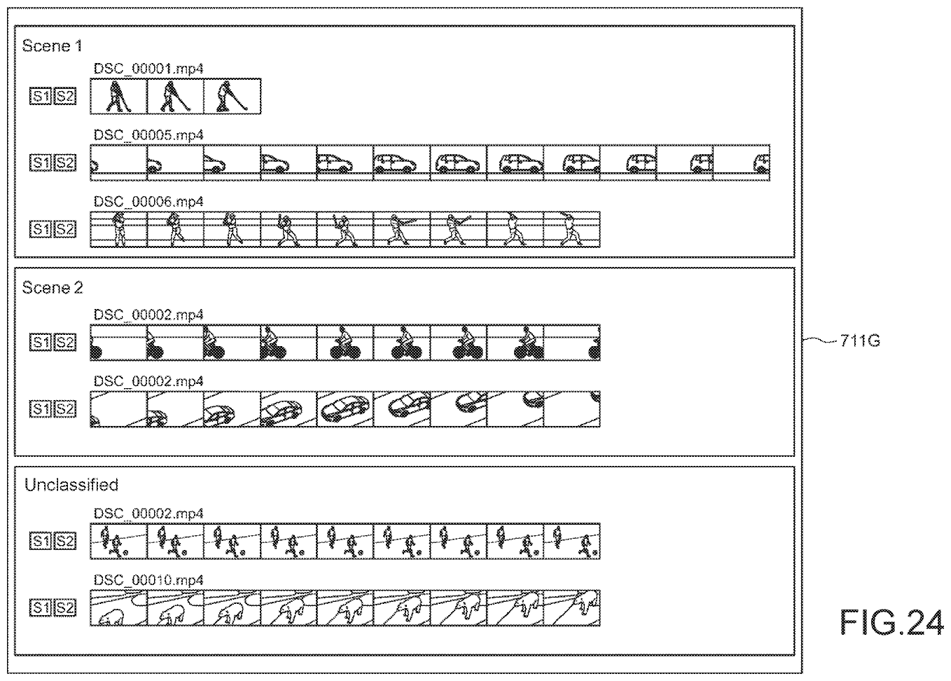

FIG. 24 is a diagram showing a display example of the seventh region 711G when an automatic creation button has been pressed. In FIG. 24, a group is expressed as a scene, and image groups for each scene, i.e., image groups of Scene 2, Scene 3, . . . , are displayed following an image group (video group) of Scene 1.

Although an image before the execution of video production is unclassified, in a basic usage method, the image is necessarily classified into one of scenes starting from Scene 1 when an automatic creation button is pressed to execute production of produced-video. That is, an image uploaded after the execution of production of produced-video is unclassified first and the scene classification thereof is performed when video production is executed again.

Note that in the case where an image is video, for a company logo or the like added to the beginning or end of video, a function of not automatically classifying the company logo or the like individually may be provided by user's settings.

In the production of produced-video, not only the function of scene classification but also, for example, a function of editing (automatic edition) which image should be actually used as produced-video (completed video) after an automatic creation button is pressed is provided. The editing result is displayed in the fourth region 711D in the editing screen 711.

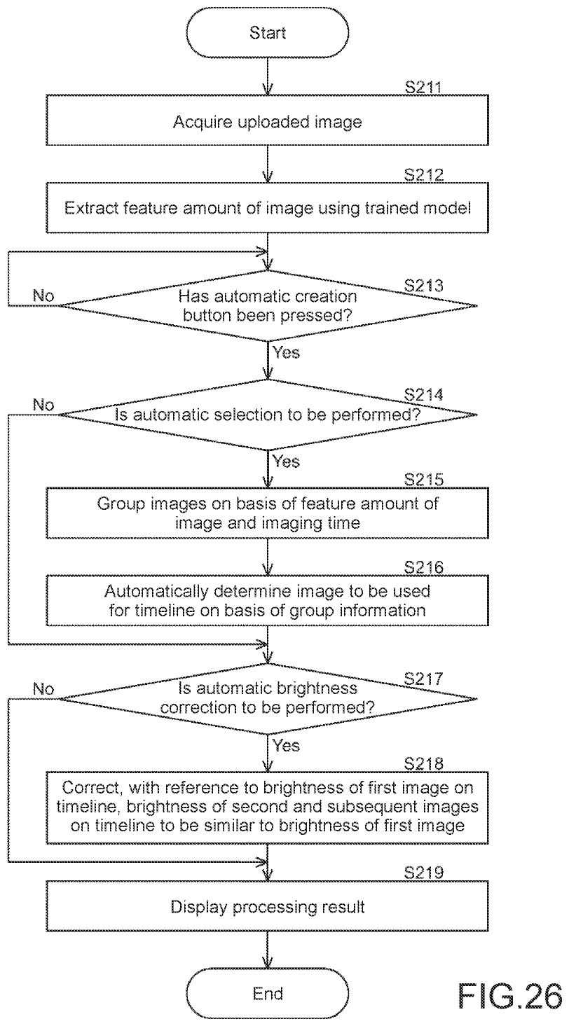

A user can refer to the editing result displayed in the fourth region 711D to, for example, perform video editing work (manual edition) such as changing to a favorite video or still image, changing the display time or transition, superimposing subtitles or a still image, changing BGM, and changing the brightness and hue. Here, those for managing the entire flow in chronological order, which are displayed in the fourth region 711D, are referred to as the timeline. The method of determining video and a still image in the timeline, the display time thereof, the transition, and the like will be described below with reference to the flowchart of FIG. 26.

### <Third Example of Setting Screen>

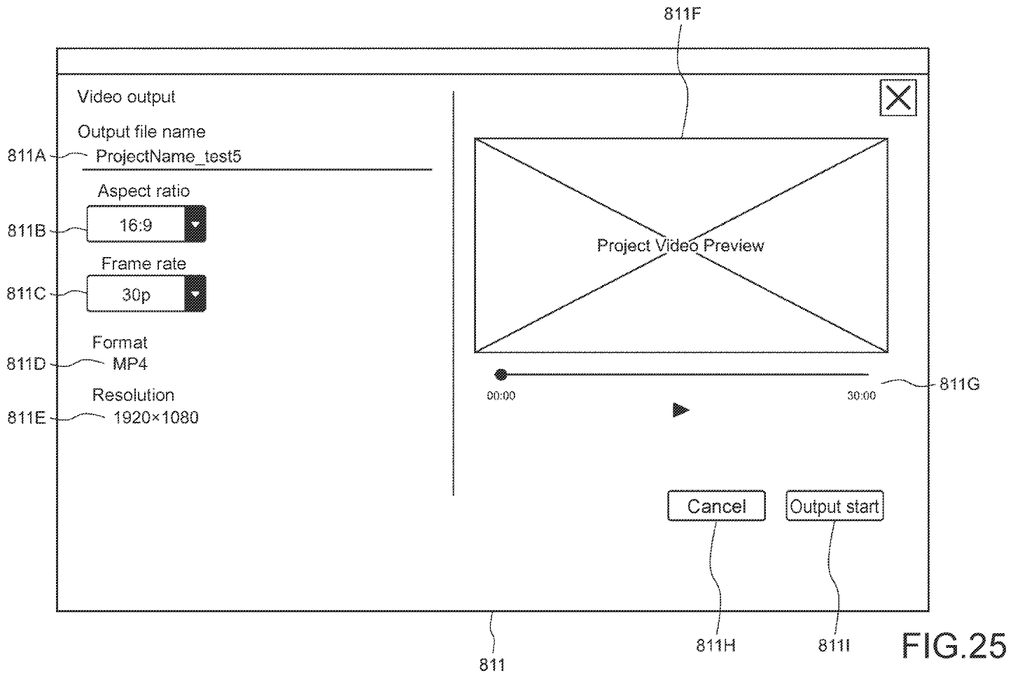

FIG. 25 is a diagram showing a third example of the setting screen to be used at the time of video output.

When an export button of the first region 711A in the editing screen 711 in FIG. 20 is pressed, processing of finally producing produced-video (completed video) is executed. At this time, the aspect ratio and the output setting of a frame rate or the like can be changed using a setting screen 811 in FIG. 25.

In FIG. 25, the setting screen 811 includes an output file name designation section 811A for designating a file name of produced-video to be output, an aspect ratio designation section 811B for designating an aspect ratio of produced-video, and a frame rate designation section 811C for setting a frame rate of produced-video. The setting screen 811 further includes a format designation section 811D for setting a format of produced-video and a resolution designation section 811E for setting a resolution of produced-video.

In the setting screen 811, by operating the output file name designation section 811A to the resolution designation section 811E, the output settings of produced-video, such as an aspect ratio of 16:9, a frame rate of 30p, a format of MP4, and a resolution of 1920×1080, can be changed.

In a video display section 811F, final produced-video (completed video) is preview-played. A playback operation section 811G includes a seek bar or the like, and the playback position or the like of produced-video (completed video) preview-displayed in the video display section 811F can be operated.

A cancel button 811H is a button for instructing to cancel production of produced-video (completed video). An output start button 811I is a button for instructing to execute production of produced-video (completed video).

### <Flow of Image Selection/Automatic Editing Processing>

Next, the flow of image selection processing and automatic editing processing will be described with reference to the flowchart of FIG. 26.

In Step S211, the image acquisition unit 251 acquires an image uploaded from a device such as the camera 10 and the terminal apparatus 30 via the network 40.

In Step S212, the processing unit 200 extracts the feature amount of the acquired image using a trained model (e.g., DNN) learned by machine learning. For example, as the feature amount of an image, a feature vector can be extracted.

Although the feature amount is always extracted here in the case where video is uploaded as an image, whether to extract the feature amount can be changed depending on the operation, settings, or the like, e.g., the extraction of a feature amount in the case where a still image is uploaded is arbitrary. The feature amount of an image can be held as feature grouping (feature_grouping) of the same content ID (content_id) as that of the image.

In Step S213, the processing unit 200 determines, on the basis of the operation information acquired by the operation information acquisition unit 253, whether or not an automatic creation button of the first region 711A in the editing screen 711 in FIG. 20 has been pressed by a user's operation. In the case where it is determined in Step S213 that an automatic creation button has been pressed, the processing proceeds to Step S214.

In Step S214, the processing unit 200 determines whether to perform automatic selection. In the case where it is determined in Step S214 that automatic selection is to be performed, the processing proceeds to Step S215.

In Step S215, the image selection unit 254 groups images on the basis of the extracted feature amount of and image and the imaging time. In Step S216, the image selection unit 254 automatically determines, on the basis of the group information, an image to be used on the timeline displayed in the fourth region 711D of the editing screen 711. In this automatic determination, a shot mark added to the image can be used.

When the processing of Step S216 is finished, the processing proceeds to Step S217. Further, in the case where it is determined in Step S214 that automatic selection is not to be performed, Step S215 and S216 are skipped and the processing proceeds to Step S217.

In Step S217, the processing unit 200 determines whether to perform automatic brightness correction. In the case where it is determined in Step S217 that automatic brightness correction is to be performed, the processing proceeds to Step S218.

In Step S218, the edition unit 255 corrects, with reference to the brightness of a first image on the timeline displayed in the fourth region 711D of the editing screen 711, the brightness of second and subsequent images on the timeline to be similar to the brightness of the first image. The brightness correction method shown here is an example and another brightness correction method may be applied.

When the processing of Step S218 is finished, the processing proceeds to Step S219. Further, in the case where it is determined in Step S217 that automatic brightness correction is not to be performed, Step S218 is skipped and the processing proceeds to Step S219.

In Step S219, the processing unit 200 displays the processing result of Steps S214 to S218 on the editing screen 711. For example, in the case where automatic selection has been performed (“Yes” in S214, S215, and S216), the group information and the timeline information are displayed in the fourth region 711D of the editing screen 711 as a processing result. Further, in the case where automatic brightness correction has been performed (“Yes” in S217, and S218), the brightness correction result is displayed in the fourth region 711D of the editing screen 711 as a processing result.

When the processing of Step S219 is finished, a series of processes is finished.

Although automatic selection is performed in Steps S215 and S216 in FIG. 26, for example, the following processing may be performed. That is, first, in the case where the time for the first cut, the time for the second cut, and the time for the complete package of produced-video are set when grouping images, since the following formula (2) and the following formula (3) are respectively derived from the following formula (1) and the formula (2), images can be grouped by requesting for grouping corresponding the number of groups obtained from the formula (3). The time for the complete package can be set as the time length of produced-video by a setting screen such as the setting screen 611 in FIG. 14 and the setting screen 621 in FIG. 16. For example, in the setting screen 621 in FIG. 16, the time for the complete package can be set by the standard time designation section 621C.

Time for first cut+time for second cut×(number of groups−1)=time for complete package (1)

Number of groups−1=(time for complete package time for first cut)/time for second cut (2)

Number of groups=1+(time for complete package−1time for first cut)/time for second cut (3)

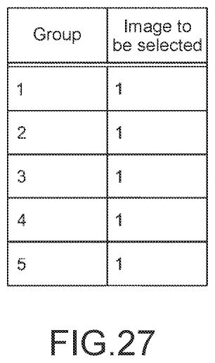

After such grouping is performed, an image is selected from each group. For example, as shown in FIG. 27, an image can be selected one by one from each group of groups 1 to 5. Note that the number of images to be selected from each group is not limited to one, a plurality of images may be selected from each group in accordance with time adjustment, and the number of images may differ for each group.

In the case where the number of images to be extracted from each group is one, first, an image to which a shot mark in the same group is added is selected. For example, there is one or more videos to which a shot mark is added in the group, a video is selected therefrom in reverse order of date and time. In the case where there is no image to which a shot mark is added, an image with a new date and time is selected.

In the case of video to which a shot mark is added, of the selected images, the cut out time is selected such that the target time such as 3 seconds and 4 seconds around the time of the shot mark is obtained. As a result, in the case where the start time of the video becomes negative or the end time exceeds the recording time, the time is adjusted such that the start time is 0 second and the end time is 3 seconds or the start time is 3 seconds before the recording time and the end time coincides with the recording time.

In the case where the target time for cut is 3 seconds but the time of video is 2 seconds, the full scale of 2 seconds is used. Along with this, even in the case where the total target time changes, a user does not need to care. Even in the case of video of 0.1 second, the video of 0.1 second is used for the time being. There is a plurality of types of shot marks, and assumption is made that a plurality of shot marks is added. In this case, the shot mark added at the latest time can be used.

Further, of the selected images, video to which no shot mark is added can be cut out with the middle time of the video as a center. For example, in the case of video of 5 seconds and video of 8 seconds, the video can be cut out with 2.5 seconds and 4 seconds as the centers, respectively. In the case of a still image, there is no concept of time, and thus, continuing display for 3 seconds in accordance with the cut can be determined, for example.

As described above, on the basis of the time length of produced-video (time of the complete package) set in a setting screen such as the setting screen 611 and the setting screen 621 and the metadata (shot mark) added to an image, an image to be used for produced-video can be selected from the uploaded images.

Here, images are grouped on the basis of the time length of produced-video (time of the complete package) and an image to be used for produced-video is selected from the grouped images on the basis of the metadata (shot mark). Further, although a case where a shot mark is used as metadata has been illustrated in this example, another parameter (e.g., a camera parameter) may be used.

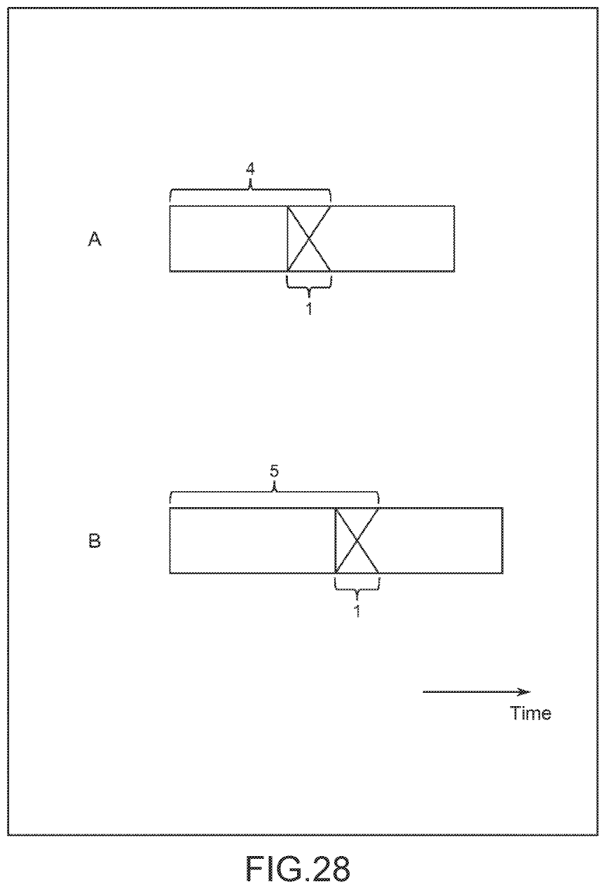

Here, for example, assuming that the video cut is 4 seconds and the transition to connect the cuts is 1 second, 0 to 1 second is a transition period, 1 to 3 seconds is a normal display period, and also 3 to 4 seconds is a transition period as shown in Part A of FIG. 28. Adding the time of corresponding to the transition second that is 1 second to the video cut of 4 seconds as shown in Part B of FIG. 28 is not performed.

Further, in Step S218 in FIG. 26, brightness correction is performed as automatic quality correction, but the following processing may be executed, for example. That is, in the case where automatic selection is requested, the image selected at the time of the automatic selection can be a target for acquiring a recommended value of brightness correction.

in the case where an image is video, although it is necessary to designate which image frame of which time is to be used, an image frame with the latest time of the shot mark time can be used in the case of video to which a shot mark is added. Further, in the case of video to which no shot mark is added, an image frame in the middle time of the video (e.g., an image frame of 2 seconds in the case of video of 4 seconds) can be used. In the case where an image is a still image, it is unnecessary to designate the time because it is, so to speak, one image frame.

Meanwhile, in the case where no automatic selection is requested and an image is video, for example, an image frame in the middle time between the start time and the end time of the video cutout set by an UI of a setting screen or the like can be used. In the case where an image is a still image, it is unnecessary to designate the time.

Note that although brightness correction has been illustrated as correction processing of an image in Step S218 in FIG. 26, other correction processing such as hue correction may be performed. Further, processing of reducing the noise such as wind noise or processing of making the volume of utterance in each video uniform may be added. Alternatively, camera shake correction may be added. For example, in the case where camera shake correction is set to be on by a setting screen or the like, camera shake correction is performed on all videos.

In Step S211 in FIG. 26, as a method of uploading an image file, a method of uploading a file to the cloud server 20 via the network 40 by performing an operation such as pressing a button and dragging and dropping from a UI of a Web browser with the terminal apparatus 30 by a user as described above can be used.

Alternatively, a method of automatically uploading an image taken by the camera 10 to the cloud server 20 via the network 40 may be used. In the terminal apparatus 30, a list of images in the camera 10 may be displayed on a Web browser and a user can select a desired image.

At this time, in the case where the camera 10 uses proxy recording, i.e., a function of recording a main image (an image having a high resolution) and a proxy image (an image having a low resolution) at the same time, a proxy image can be uploaded to the cloud server 20 first to execute automatic edition and a main image can be uploaded to the cloud server 20 by the time produced-video (completed video) is actually created. As a result, it is possible to reduce the time for communication.

As described above, in the present disclosure, it is possible to provide a video production service that is highly satisfying to a user. In particular, although there has been a problem that a user who is not proficient in video editing was not able to master a video editing function and was not able to produce satisfactory video, it is possible to easily produce desired video by simply following a procedure by means of the flow of a user's operation necessary for editing and specification of a functional element necessary for editing, in the present disclosure.

Further, a user can realize high-quality video production by automatic correction using camera metadata without the need for an imaging technique or dedicated equipment. Further, the composition of video such as an advertisement can be easily created using a template or can be inserted into a template using camera metadata. A selection function makes it possible to support clip sorting and scene selection. A user can automatically produce, at the end of imaging, produced-video such as an advertisement by simply imaging a desired subject.

### <Modified Example>

The processing performed in the above-mentioned editing processing is an example. For example, an undo/redo function or a basic editing function such as speed changes including slowing down and speeding up may be added. The undo means to cancel the immediately preceding processing content to return to the state before the processing. The redo means to conversely return the processing cancelled by the undo to the original state. Further, at the time of automatic selection of video and creation of the timeline, for example, effects such as panning, tilting, and zooming may be added. Further, a function of automatically transcribing the utterance of voice may be added.

Although the processing unit 200 of the cloud server 20 executes processing such as editing processing in the video production system 1 in the above description, the processing may be executed in a device other than the cloud server 20. For example, a processing unit of the terminal apparatus 30 may have a function corresponding to the processing unit 200 to execute all or part of the processing such as editing processing.

Further, although a case where a screen (a setting screen, an editing screen, or the like) from the cloud server 20 is a Web page, provided to the terminal apparatus 30 via the network 40, and displayed as a UI of a Web browser has been illustrated in the above description, the UI on the terminal side is not limited thereto. For example, in the terminal apparatus 30, dedicated software (including a so-called native application) may be installed and executed to realize the function relating to the UI on the terminal side, such as a setting screen and an editing screen.

The processing of each Step of the above-mentioned flowchart may be performed by hardware or may be performed by software. When the series of processes is executed using software, a program constituting the software is installed in a computer of each apparatus.

The program executed by the computer can be recorded on, for example, a removable recording medium as a package medium or the like and provided. Further, the program can be provided via a wired or wireless transmission medium such as a LAN, the Internet, and digital satellite broadcasting.

In the computer, the program can be installed in a storage unit via an input/output I/F by attaching the removable recording medium to a drive. Further, the program can be received by a communication unit via a wired or wireless transmission medium and installed in a storage unit. In addition, the program can be installed in a ROM or a storage unit in advance.

Here, in the specification, the processes performed by a computer in accordance with a program do not necessarily need to be chronologically performed in the order of the descriptions in the flowcharts. That is, the processes performed by a computer in accordance with a program include processes performed in parallel or individually (e.g., parallel processing or processing performed using an object).

Further, the program may be a program on which processing is performed by a single computer (processor) or may be a program on which distributed-processing is performed by a plurality of computers. Further, the program may be transferred to a remote computer to be executed by the remote computer.

The embodiment of the present disclosure is not limited to the embodiment described above, and various modifications can be made without departing from the essence of the present disclosure.

In the specification, the description of “automatic” means that a device such as the cloud server 20 performs processing without a direct operation by a user and the description of “manual” means that the device performs processing with a direct operation by a user. Further, the effects described in the specification are merely illustrative and not limitative, and other effects may be provided.

In the specification, the system means a set of a plurality of components (such as devices and modules (parts)) and it does not matter whether all of the components are in the same casing. Therefore, the system includes both a plurality of apparatuses housed in separate casings and connected via a network and a single apparatus in which a plurality of modules is housed in one casing.

Further, the present disclosure may take the following configurations.

(1) An image processing apparatus, including:
a processing unit that
   acquires an image to which metadata is added, the image including a plurality of images,
   selects, on a basis of a time length of video to be produced and the metadata, the image to be used for production of the video from the acquired images, the time length being set on a setting screen, and
   produces the video using the selected image.

(2) The image processing apparatus according to (1) above, in which
the metadata includes camera metadata added by a camera that has taken the image.

(3) The image processing apparatus according to (2) above, in which
the metadata includes a shot mark to be added to the image in accordance with a user's operation.

(4) The image processing apparatus according to (3) above, in which
the processing unit
   groups the acquired images on a basis of the time length of video, and
   selects, on a basis of the shot mark, the image to be used for production of the video from the grouped images.

(5) The image processing apparatus according to any one of (1) to (4) above, in which
the time length of video is set on the setting screen in accordance with a user's operation before production of the video.

(6) The image processing apparatus according to any one of (1) to (4) above, in which
the time length of video is set on the setting screen in accordance with a user's operation before taking the image.

(7) The image processing apparatus according to any one of (1) to (6) above, in which
the time length of video is changeable on an editing screen for editing the video.

(8) The image processing apparatus according to any one of (1) to (7) above, in which
the number of the images to be used for production of the video is further set on the setting screen, and
the processing unit selects the image on a basis of the set time length of video, the set number of the images, and the metadata.

(9) The image processing apparatus according to any one of (1) to (8) above, in which
an aspect ratio is further set on the setting screen, and
the processing unit produces the video corresponding to the set aspect ratio.

(10) The image processing apparatus according to any one of (1) to (9) above, in which
the image is video or a still image.

(11) The image processing apparatus according to any one of (1) to (10) above, which is configured as a server that processes the image taken by a camera operated by a user, the image being received via a network, and transmits the produced video to a terminal apparatus operated by a user.

(12) The image processing apparatus according to (11) above, in which
the setting screen is displayed on the terminal apparatus and operated by the user.

(13) An image processing method, including:
by an image processing apparatus,
acquiring an image to which metadata is added;
selecting, on a basis of a time length of video to be produced and the metadata, the image to be used for production of the video from the acquired images, the time length being set on a setting screen; and
producing the video using the selected image.

(14) A program that causes a computer to function as a processing unit that
acquires an image to which metadata is added,
selects, on a basis of a time length of video to be produced and the metadata, the image to be used for production of the video from the acquired images, the time length being set on a setting screen, and
produces the video using the selected image.

### REFERENCE SIGNS LIST

1 video production system, 10 camera, 20 cloud server, 30 a terminal apparatus, 40-1,40-2, 40 network, 200 processing unit, 211 CPU, 251 image acquisition unit, 252 metadata extraction unit, 253 operation information acquisition unit, 254 image selection unit, 255 edition unit

1. An image processing apparatus, comprising:
a processing unit that
acquires an image to which metadata is added, the image including a plurality of images,
selects, on a basis of a time length of video to be produced and the metadata, the image to be used for production of the video from the acquired images, the time length being set on a setting screen, and
produces the video using the selected image.

2. The image processing apparatus according to claim 1, wherein
the metadata includes camera metadata added by a camera that has taken the image.

3. The image processing apparatus according to claim 2, wherein
the metadata includes a shot mark to be added to the image in accordance with a user's operation.

4. The image processing apparatus according to claim 3, wherein
the processing unit
groups the acquired images on a basis of the time length of video, and
selects, on a basis of the shot mark, the image to be used for production of the video from the grouped images.

5. The image processing apparatus according to claim 1, wherein
the time length of video is set on the setting screen in accordance with a user's operation before production of the video.

6. The image processing apparatus according to claim 1, wherein
the time length of video is set on the setting screen in accordance with a user's operation before taking the image.

7. The image processing apparatus according to claim 1, wherein
the time length of video is changeable on an editing screen for editing the video.

8. The image processing apparatus according to claim 1, wherein
the number of the images to be used for production of the video is further set on the setting screen, and
the processing unit selects the image on a basis of the set time length of video, the set number of the images, and the metadata.

9. The image processing apparatus according to claim 1, wherein
an aspect ratio is further set on the setting screen, and
the processing unit produces the video corresponding to the set aspect ratio.

10. The image processing apparatus according to claim 1, wherein
the image is video or a still image.

11. The image processing apparatus according to claim 1, which is configured as a server that processes the image taken by a camera operated by a user, the image being received via a network, and transmits the produced video to a terminal apparatus operated by a user.

12. The image processing apparatus according to claim 11, wherein
the setting screen is displayed on the terminal apparatus and operated by the user.

13. An image processing method, comprising:
by an image processing apparatus,
acquiring an image to which metadata is added;
selecting, on a basis of a time length of video to be produced and the metadata, the image to be used for production of the video from the acquired images, the time length being set on a setting screen; and
producing the video using the selected image.

14. A program that causes a computer to function as a processing unit that
acquires an image to which metadata is added,
selects, on a basis of a time length of video to be produced and the metadata, the image to be used for production of the video from the acquired images, the time length being set on a setting screen, and
produces the video using the selected image.
